(19) United States
(12) Patent Application Publication
(10) Pub. No.: US 2011/0221578 A1
(43) Pub. Date: Sep. 15, 2011

(54) WIRELESS IDENTIFICATION CARD

(75) Inventors: Takashi Sekiguchi, Osaka (JP); Shingo Kambe, Osaka (JP); Satoko Kambe, Osaka (JP); Takeyuki Yamaki, Nara (JP)

(73) Assignee: Panasonic Electric Works Co., Ltd., Osaka (JP)

(21) Appl. No.: 12/998,019

(22) PCT Filed: Sep. 9, 2009
(86) PCT No.: PCT/JP2009/065746

§ 371 Date: May 23, 2011

(30) Foreign Application Priority Data
Sep. 10, 2008 (JP) 2008-232679
Sep. 10, 2008 (JP) 2008-232680
Sep. 11, 2008 (JP) 2008-233892
Jan. 19, 2009 (JP) 2009-009193

(51) Int. Cl. G06F 7/04

(52) U.S. Cl. 340/10.42

(57) ABSTRACT

The wireless identification card (10) includes an identification information storage (11) configured to store identification information, and a transmitter (12) configured to transmit, to a reader (90), a wireless signal including the identification information stored in the identification information storage (11). The wireless identification card (10) further includes a solar cell (15) configured to supply electrical power to the transmitter (12). The solar cell (15) includes a sensitizing material having sensitization action, a semiconductor layer (1513) defined as an electron transport member, and an electrolyte layer (1514) defined as a hole transport member.

### TECHNICAL FIELD

The present invention is directed to wireless identification cards, and particularly to a wireless identification card incorporating a battery for wireless communication.

### BACKGROUND ART

In recent years, a contactless identification system has become common. The contactless identification system includes a thin wireless identification card which is portable for a user, and a reading device (reader) which communicates with the wireless identification card to retrieve identification information from the wireless identification card. The contactless identification system judges whether or not the user is allowed to pass through an automatic ticket checker or a gate, on the basis of the identification information retrieved from the wireless identification card.

As the wireless identification card, a passive wireless identification card and an active wireless identification card have been provided. The passive wireless identification card is provided with no battery supplying electrical power for a wireless communication. An example of the passive wireless identification is a passive RF tag (passive tag). The active wireless identification card is provided with a battery supplying electrical power for a wireless communication. An example of the active wireless identification is an active RF tag (active tag).

The passive wireless identification card has a relatively short communication range within which the passive wireless identification card is enabled to communicate with the reading device. Therefore, a user is required to place the passive wireless identification card close to the reading device.

In contrast, the active wireless identification card has the communication range greater than that of the passive wireless identification card. For example, even when a distance between the active wireless identification card and the reading device is 10 m, the active wireless identification card can communicate with the reading device. Thus, when the wireless identification card is the active one, the user need not place the wireless identification card close to the reading device, but is only required to move close to the reading device.

However, if a battery of the active wireless identification card is a primary cell, a user is required to perform a regular maintenance (e.g., battery exchange).

To adopt a solar cell in order to eliminate battery exchange is disclosed in Japanese Patent Publication Laid-Open No. 2004-24551.

The passive wireless identification card provided with a liquid crystal display panel as an indicating means is disclosed in Japanese Patent Publications Laid-Open No. 2002-32728 and 10-240873. This wireless identification card includes a solar cell configured to supply electrical power to the liquid crystal display panel.

In order to overcome above insufficiency of the active wireless identification card, the present inventors have conceived of adopting a general crystalline silicon solar cell, a polysilicon solar cell, or a compound semiconductor solar cell as a power supply source of the active wireless identification card.

However, it has found that it is difficult to supplement electric power used in the wireless identification card by use of the aforementioned solar cell.

A main reason is that the aforementioned solar cell has no photoelectric conversion performance enough to generate sufficient electrical power in a usage environment of the wireless identification card.

In other words, the wireless identification card is frequently used in doors (rooms). Therefore, light coming into the solar cell is indoor light rather than sunlight. The indoor light is lower in luminance than the sunlight, and is defined as light emitted from a fluorescent lamp, for example. A general crystalline silicon solar cell, a polysilicon solar cell, and a compound semiconductor solar cell can exert sufficient power generation capacity (in other words, photoelectric conversion performance) under the sunlight, but suffer from insufficient power generation capacity under the indoor light. Therefore, the above solar cells may fail to generate electrical power necessitated for operation of the wireless identification card.

It is considered to increase electric power generation by enlarging the solar cell. However, the wireless identification card is desired to have a size convenient for a user to carry the wireless identification card. As mentioned in the above, in view of portability of the wireless identification card, the size of the wireless identification card is limited, and a size of the solar cell is limited, too. Therefore, it is not preferable to increase the electric power generation by enlarging the solar cell.

### DISCLOSURE OF INVENTION

In view of the above insufficiency, the present invention has been aimed to propose a wireless identification card which is capable of supplementing consumed power under a low illumination environment (e.g., in doors) by use of only a solar cell of limited size.

The wireless identification card of the present invention includes an identification information storage configured to store identification information, a transmitter configured to transmit a wireless signal including the identification information stored in the identification information storage, and a solar cell configured to supply electrical power to the transmitter. The solar cell includes a sensitizing material having sensitization action, an electron transport member, and a hole transport member.

The present invention can improve electrical power generation under the low illumination environment (e.g. in doors) in contrast to the wireless identification card employing a general crystalline silicon solar cell. Therefore, even if the wireless identification card is frequently used indoors, it is possible to supplement consumed power by use of only the solar cell of limited dimensions. Further, it is possible to reduce a production cost of the solar cell.

In a preferred embodiment, the wireless identification card includes an indication unit shaped into a plate shape and configured to indicate predetermined visual information, a main body shaped into a card shape and configured to hold the identification information storage and the transmitter. The sensitizing material is a dye which generates an electron and a hole in response to reception of light. The solar cell is shaped into a plate shape, and further includes a working electrode, and an opposite electrode. The electron transport member is made of a semiconductor layer and configured to support the sensitizing material. The working electrode is formed over a first surface of the electron transport member in its thickness direction and configured to receive an electron from the sensitizing material. The opposite electrode is formed over a second surface of the electron transport member in its thickness direction. The hole transport member is defined as an electrolyte layer interposed between the electron transport member and the opposite electrode and configured to receive a hole from the sensitizing material. One of the solar cell and the indication unit is configured to have translucency, and disposed over a front surface of the main body such that the other of the solar cell and the indication unit is interposed between the one of the solar cell and the indication unit and the main body.

According to this embodiment, in contrast to a prior art in which the solar cell and the indication unit are arranged in parallel on the same plane, it is possible to enlarge the surface area of each of the solar cell and the indication unit. Accordingly, it is possible to improve the visibility of the indication unit and the electrical power generation of the solar cell. Since the solar cell energizes the communication device and the indication unit, the maintenance (e.g., battery exchange) is unnecessary. With controlling the indication unit to indicate a user's name and/or the like, the wireless identification card can be used as a name tag.

In a more preferred embodiment, the indication unit is configured to have translucency, and is disposed over the front surface of the main body such that the solar cell is interposed between the indication unit and the main body. The wireless identification card includes a diffusion transmission member interposed between the indication unit and the solar cell. The diffusion transmission member is configured to, upon receiving light, diffuse the light used for visual indication by the indication unit, and transmit the light used for electrical generation of the solar cell.

According to this embodiment, since a part of the light passing through the indication unit is diffused by the diffusion transmission member, the visibility of the visual indication of the indication unit can be improved. Further, the solar cell generates electric power by use of the light which passes through the diffusion transmission member. Therefore, both the visual indication by the indication unit and the generation of electric power by the solar cell are realized by use of only the incoming light from one side.

Alternatively, in a more preferred embodiment, the solar cell has translucency for visible light, and is disposed over the main body such that the indication unit is interposed between the solar cell and the main body.

According to this embodiment, the solar module easily receives light in contrast to an instance where the solar cell is disposed in back of the indication unit. Therefore, the electrical power generation of the solar cell can be increased.

In a further preferred embodiment, the indication unit has translucency. The wireless identification card includes a background plate which is disposed over a rear surface of the indication unit and is configured to improve visibility of visual indication by the indication unit.

According to this embodiment, it is possible to improve the visibility of the visual indication of the indication unit. Accordingly, the indication device gives at its indication screen the visual indication which is easily recognized even when it is viewed from a distance.

Alternatively, in a further preferred embodiment, the indication unit has translucency. The wireless identification card includes a reflective plate which is disposed over a rear surface of the indication unit and is configured to reflect the light which passes through the indication unit.

According to this embodiment, the solar cell can make photoelectric conversion by use of light reflected by the reflective plate in addition to light which directly comes into the solar cell. As a result, the electrical power generation of the solar cell can be increased.

Alternatively, in a more preferred embodiment, the wireless identification card further includes a receiver is configured to receive a wireless signal including indication information which defines visual indication indicated by the indication unit, and an indication information storage configured to store the indication information received by the receiver. The indication unit is configured to make visual indication corresponding to the indication information stored in the indication information storage. The solar cell is configured to energize the receiver and the indication unit.

According to this embodiment, it is possible to indicate a desired visual indication by use of the indication unit.

In a further preferred embodiment, the wireless identification card includes an updating device configured to update contents of the indication information stored in the indication information storage to contents of the indication information received by the receiver.

According to this embodiment, it is possible to update the visual indication made by the indication unit.

Alternatively, in a more preferred embodiment, the indication unit is disposed over the front surface of the may body such that the solar cell is interposed between the indication unit and the main body. The solar cell is defined by common base plate, and a photoelectric conversion member formed over the common base plate, the photo electric conversion member including the working electrode, the semiconductor layer, the electrolyte layer, and the opposed electrode. The transmitter is defined by the common base plate, an antenna formed over the common base plate, and a communication circuit formed over the common base plate and configured to transmit a wireless signal by use of the antenna.

According to this embodiment, it is possible to thin the wireless identification card.

In a more preferred embodiment, the photoelectric conversion member, the antenna, and the communication circuit are formed over a surface of the common base plate in its thickness direction.

According to this embodiment, in contrast to the wireless identification card in which the photoelectric conversion member, the antenna, and the communication circuit are formed over the different surfaces of the common base plate, it is possible to thin the wireless identification card.

Alternatively, in a more preferred embodiment, the photoelectric conversion member is formed over a first surface of the common base plate in its thickness direction. The antenna and the communication circuit are formed over a second surface of the common base plate in its thickness direction.

According to this embodiment, in contrast to the wireless identification card in which the photoelectric conversion member, the antenna, and the communication circuit are formed over the same surface of the common base plate, it is possible to downsize the wireless identification card.

Alternatively, in a more preferred embodiment, the wireless identification card further includes a storage cell configured to store electrical power generated by the solar cell. The storage cell is defined by the common base plate and a storage cell member formed over the common base plate.

According to this embodiment, even if the solar cell fails to supply sufficient electrical power to the communication circuit due to a decrease in an amount of light coming into the solar cell, the communication circuit can operate by receiving electrical power from the storage cell.

Alternatively, in a more preferred embodiment, the indication unit is disposed over the front surface of the may body such that the solar cell is interposed between the indication unit and the main body. The solar cell is defined by a photoelectric conversion member and a reflector, the photoelectric conversion member being defined by the working electrode, the semiconductor layer, the electrolyte layer, and the opposed electrode, and the reflector being configured to reflect light which passes through the photoelectric conversion member. The transmitter is defined by a base plate, an antenna formed over the base plate, and a communication circuit formed over the base plate and configured to transmit a wireless signal by use of the antenna. The reflector is the base plate or the antenna.

According to this embodiment, it is possible to increase the electrical power generation of the solar cell, and further to thin the wireless identification card.

Alternatively, in a more preferred embodiment, the wireless identification card further includes a storage cell configured to store electrical power generated by the solar cell. The indication unit is disposed over a front surface of the solar cell. The solar cell is defined by a common base plate and a photoelectric conversion unit formed over the common base plate and including the working electrode, the semiconductor layer, the electrolyte layer, and the opposed electrode. The storage cell is defined by the common base plate and a storage cell member formed over the common base plate.

According to this embodiment, it is possible to downsize the wireless identification card. Additionally, even if the solar cell fails to supply sufficient electrical power to the communication circuit due to a decrease in an amount of light coming into the solar cell, the communication circuit can operate by receiving electrical power from the storage cell. Further, since the solar cell and the storage cell are provided as a single part, it is possible to decrease the number of parts for assembling the wireless identification card.

### BRIEF DESCRIPTION OF DRAWINGS

FIG. 1A is a block diagram illustrating a wireless identification card of the first embodiment,

FIG. 1B is a schematic cross sectional view illustrating a solar cell of the above wireless identification card,

FIG. 2 is a block diagram illustrating a contactless identification system using the above wireless identification card,

FIG. 3A is a perspective view illustrating the wireless identification card of the first embodiment,

FIG. 3B is an exploded perspective view illustrating the wireless identification card of the first embodiment,

FIG. 4A is a chemical formula of the dye (K19) used in the above solar cell,

FIG. 4B is a chemical formula of the dye (K77) used in the above solar cell,

FIG. 4C is a chemical formula of the dye (Z907) used in the above solar cell,

FIG. 5A is a chemical formula of the other dye used in the above solar cell,

FIG. 5B is a chemical formula of the other dye used in the above solar cell,

FIG. 6 is an explanatory view illustrating a usage example of the above wireless identification card,

FIG. 7 is an exploded perspective view illustrating a modification of the above wireless identification card,

FIG. 8A is an exploded perspective view illustrating a modification of the above wireless identification card,

FIG. 8B is an explanatory view illustrating a usage example of the above wireless identification card,

FIG. 9 is a perspective view illustrating a modification of the above wireless identification card,

FIG. 10A is an exploded perspective view illustrating a wireless identification card of the second embodiment,

FIG. 10B is a schematic cross sectional view illustrating the wireless identification card of the second embodiment,

FIG. 11 is a partially omitted schematic cross sectional view illustrating a wireless identification card of the third embodiment,

FIG. 12A is a schematic cross sectional view illustrating a transmission unit of a reference of the above wireless identification card,

FIG. 12B is a schematic cross sectional view illustrating a solar cell of the reference of the above wireless identification card,

FIG. 12C is a partially omitted schematic cross sectional view illustrating the reference of the above wireless identification card,

FIG. 13 is a partially omitted schematic cross sectional view illustrating a modification of the wireless identification card,

FIG. 14A is a schematic cross sectional view illustrating a transmission unit of a reference of the above wireless identification card,

FIG. 14B is a schematic cross sectional view illustrating a solar cell of the reference of the above wireless identification card,

FIG. 14C is a partially omitted schematic cross sectional view illustrating the reference of the above wireless identification card,

FIG. 15 is a partially omitted schematic cross sectional view illustrating a wireless identification card of the fourth embodiment,

FIG. 16A is a schematic cross sectional view illustrating a solar cell of a reference of the above wireless identification card,

FIG. 16B is a schematic cross sectional view illustrating a storage cell of the reference of the above wireless identification card,

FIG. 16C is a partially omitted schematic cross sectional view illustrating the reference of the above wireless identification card,

FIG. 17 is a partially omitted schematic cross sectional view illustrating a modification of the above wireless identification card,

FIG. 18A is an exploded perspective view illustrating a wireless identification card of the fifth embodiment,

FIG. 18B is an exploded perspective view illustrating a modification of the above wireless identification card,

FIG. 19 is an exploded perspective view illustrating a reference of the above wireless identification card,

FIG. 20A is a block diagram illustrating a wireless identification card of the sixth embodiment,

FIG. 20B is a block diagram illustrating an authentication device constructing an entrance and exit management system in association with the above wireless identification card,

FIG. 21 is a schematic diagram illustrating an application of the entrance and exit management system using the above wireless identification card, and

FIG. 22 is a flow chart illustrating operation of a mode control device of the above.

### BEST MODE FOR CARRYING OUT THE INVENTION

### First Embodiment

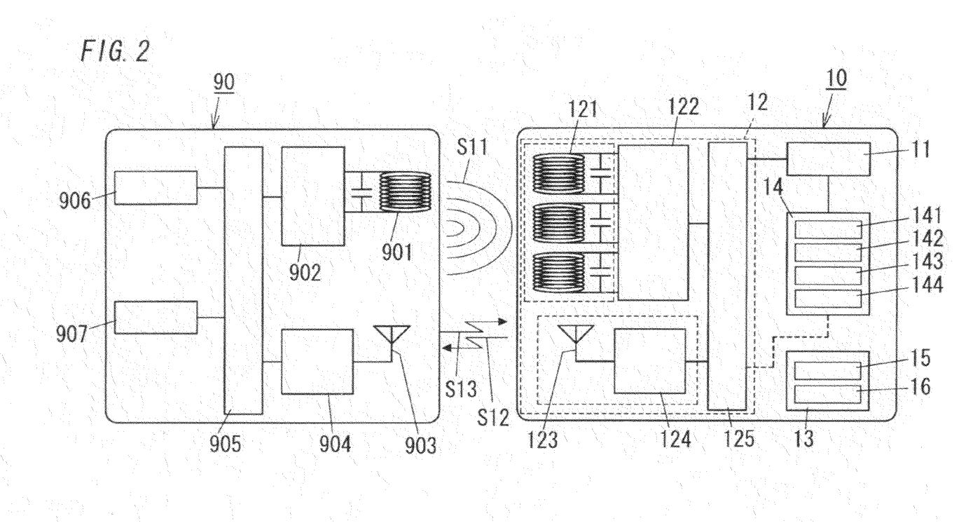

FIG. 2 shows a contactless identification system employing a wireless identification card 10 of the present embodiment. The contactless identification system includes the wireless identification card 10 and a dedicated reading device (reader) 90 configured to establish contactless communications (wireless communications) with the wireless identification card 10. For example, the contactless identification system is used to make personal authentication by means of the contactless communications between the wireless identification card 10 and the reading device 90, at an entrance door, an exit door, and an automatic door of premises, and an automatic ticket gate. This contactless identification system only requires a user to have the wireless identification card 10 in order to make an entrance and exit management for a room.

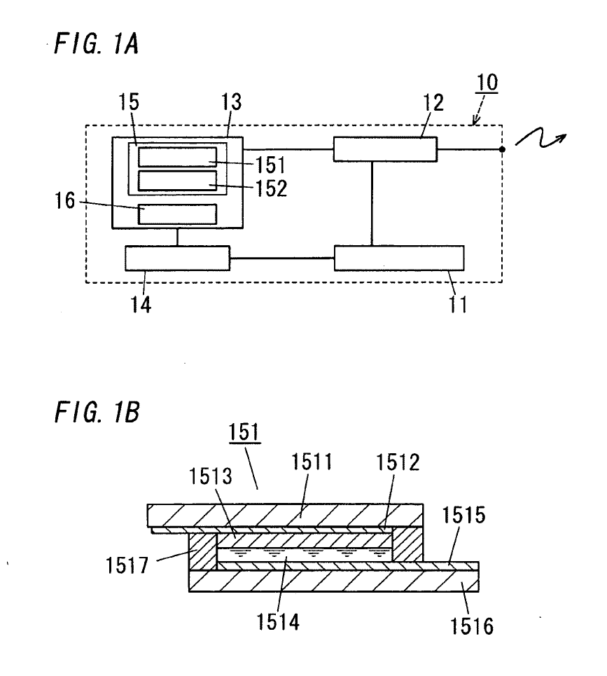

The wireless identification card 10 is, as shown in FIG. 1A, defined as a flat contactless identification device including an identification information storage 11, a communication device 12, a power supply device 13, and an indication device 14.

The identification information storage 11 is realized by a memory, for example. The identification information storage 11 is configured to store the identification information. For example, the identification information is defined as information for identifying a person who has the wireless identification card 10. Alternatively, the identification information may be defined as information for identifying the wireless identification card 10. Besides, the identification information storage 11 is not limited to a memory, but may be a dip switch or other storage devices.

The communication unit 12, as shown in FIG. 2, includes LF antennas 121 and an LF reception circuit 122. The LF reception circuit 122 is defined as a communication circuit configured to communicate with the reading device 90 by use of the LF antennas 121 in a first communication manner (LF) using an LF band (low-frequency band: 30 to 300 kHz). Further, the communication unit 12 includes an RF antenna 123 and an RF communication circuit 124. The RF communication circuit 124 is defined as a communication circuit configured to communicate with the reading device 90 by use of the RF antenna 123 in a second communication manner (UHF) using a UHF band (ultra high frequency band: 300 MHz to 3 GHz). In addition, the communication unit 12 includes a communication control circuit 125 configured to control the LF reception circuit 122 and the RF communication circuit 124. The LF antennas 121 are loop antennas formed over a mounting substrate of a main body 20 which is used as a substrate for forming the communication device 12, for example. The RF antenna 123 is a patch antenna formed over the mounting substrate of the main body 20, for example.

The communication device 12 functions as a transmitter which is configured to transmit, to an external device (e.g., the reading device 90), a wireless signal including the identification information stored in the identification information storage 11. Further, the communication unit 12 functions as a receiver which is configured to receive, from an external device (e.g., a rewriting device), a wireless signal including indication information defining visual indication to be indicated by the indication device 14. Besides, when the rewriting device communicates with the wireless identification card 10, authentication by use of the identification information of the wireless identification card may be made.

The indication device 14 is defined as an indication unit configured to indicate predetermined visual information (an information indicating means for visually indicating information). The indication device 14 is shaped into a plate shape. The indication device 14 is, for example, a reflective liquid crystal display, and has translucency. The indication device 14 includes an indication screen 141 which is shaped into a plate shape and has translucency. The indication screen 141 is, for example, a liquid crystal panel. The indication screen 141 may be selected one from an indication panel using electrochromic materials and an indication panel using photochromic materials. The indication device 14 includes an indication information storage 142 configured to indication information received by the communication device 12 being the receiver. The indication information storage 142 is realized by a memory, for example. Additionally, the indication device 14 includes an indication control circuit 143 configured to display, on the indication screen 141, contents defined by the indication information stored in the indication information storage 142. In brief, the indication control circuit 143 controls the contents (visual indication on the indication screen 141) to be indicated on the indication screen 141. Moreover, the indication device 14 includes an updating device 144 configured to update contents of the indication information stored in the indication information storage 142 to contents of the indication information received by the communication device 12.

As described in the above, the indication device 14 is configured to make the visual indication corresponding to the indication information stored in the indication information storage 142. Upon receiving the indication information from an external device (e.g., the rewriting device), the indication device 14 updates contents to be displayed on the indication screen 141 to contents defined by the received indication information.

Besides, the reading device 90 is installed at an entrance of a room, for example. The reading device 90 includes an LF antenna 901, an LF transmission circuit 902, an RF antenna 903, an RF communication circuit 904, a control circuit 905, an indication device 906 being a liquid crystal display, and a buzzer 907. The LF antenna 901 and the LF transmission circuit 902 constitute a transmitter configured to communication with the wireless identification card 10 in the first communication manner (LF) using the LF band (low frequency band: 30 to 300 kHz). The RF antenna 903 and the RF communication circuit 904 constitute a transceiver configured to communication with the wireless identification card 10 in the second communication manner (UHF) using the UHF band (ultra high frequency band: 300 MHz to 3 GHz). The control circuit 905 is configured to control the LF transmission circuit 902 and the RF communication circuit 904.

Next, an explanation is made to the contactless identification system shown in FIG. 2.

In the reading device 90, the control circuit 905 creates an activation signal S11 defined as a wireless signal for activating the wireless identification card 10. The activation signal S11 is superimposed on a signal component of an inductive magnetic field by the LF transmission circuit 902, and is amplified. Thereafter, the activation signal S11 is transmitted from the LF antenna 901. The activation signal S11 is transmitted at predetermined intervals (intermittently). The reading device 90 transmits the activation signal 511 to form an authentication area (an area within which the wireless identification card 10 can receive the activation signal S11) around the reading device 90 (e.g., a vicinity of the entrance of the room).

When a user carrying the wireless identification card 10 comes into the authentication area, the wireless identification card 10 receives the activation signal S11 at the LF antennas 121. When the LF antennas 121 receive the activation signal S11, the LF reception circuit 122 activates the communication control circuit 125. The communication control circuit 125 creates an identification signal S12 defined as a wireless signal including the identification information stored in the identification information storage 11. The identification signal S12 is transmitted to the reading device 90 in the second communication manner by the RF communication circuit 124 and the RF antenna 125.

The wireless identification card 10 operates in a low power consumption mode until receiving the activation signal S11. The wireless identification card 10 starts to operate in a normal mode upon receiving the activation signal S11. In the low power consumption mode, the power supply device 13 supplies electrical power only to the LF reception circuit 122 of the communication device 12. In the normal mode, the power supply device 13 supplies electrical power to the RF communication circuit 124 and the communication control circuit 125 in addition to the LF reception circuit 122.

The reading device 90 receives the identification signal S12 by use of the RF antenna 903 and the RF communication circuit 904. The received identification signal S12 is transferred from the control circuit 905 to an upper device (e.g., an authentication device) not shown. The upper device checks the identification information included in the identification signal S12. When the identification information is judged to be valid on the basis of the checking result, the upper device determines success of the authentication, and notifies the reading device 90 of the success of the authentication. In this situation, the control circuit 905 in the reading device 90 creates an acknowledge signal (ACK signal) S13 including the identification information derived from the identification signal S12. The acknowledge signal S13 is transmitted to the wireless identification card 10 by use of the RF communication circuit 904 and the RF antenna 903. The control circuit 905 controls the indication device 906 and/or the buzzer 907 to notify the user of the success of the authentication. In addition, the control circuit 905 unlocks the entrance door of the room. By contrast, when the upper device determines failure of the authentication of the identification information, the control circuit 905 controls the indication device 906 and/or the buzzer to warn the user. In this situation, the entrance door of the room is kept locked.

When the RF communication circuit 124 receives the confirmation signal S13, the wireless identification card 10 terminates transmitting the identification signal S12.

Besides, the reading device 90 may transmit, instead of the acknowledge signal S13, the activation signal S11 including the identification information which has been authenticated by the upper device. With this arrangement, the wireless identification card 10 terminates transmitting the identification signal S12 when the LF reception circuit 122 receives the activation signal S11 including the identification information of the wireless identification card 10.

In the contactless identification system shown in FIG. 2, the wireless identification card 10 activates in response to the activation signal S11 in the LF band, and transmits the identification signal S12 in the UHF band. Therefore, the authentication area can be successfully set to extend a predetermined range (e.g., 1.5 to 2 m). The RF communication circuit 124 requires relatively high power consumption of 10 to 20 mA when establishing the wireless communication in the UHF band, while the LF reception circuit 122 can be energized only with slight electrical power in a range of μA order for establishing the wireless communication in the LF band. Thus, by adopting the aforementioned low power consumption mode, it is possible to reduce standby power of the wireless identification card 10.

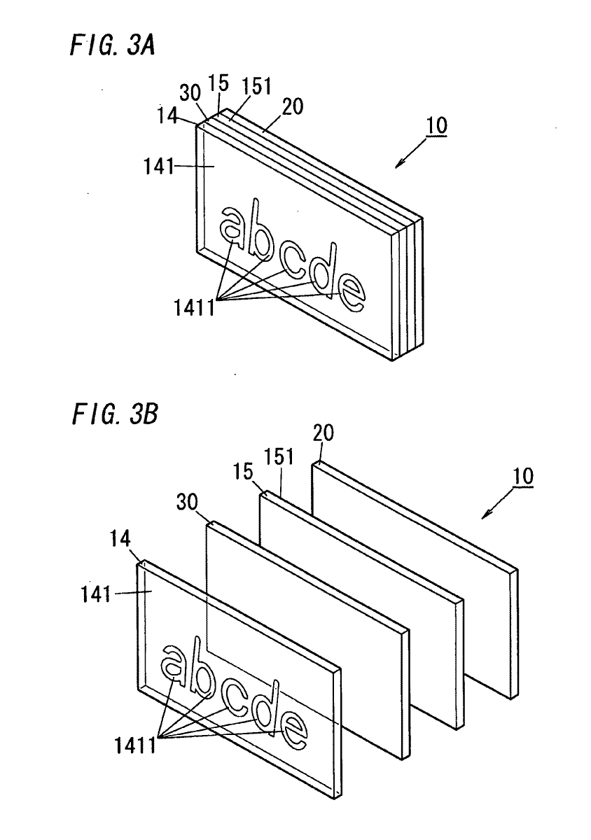

When the communication unit 12 communicates with the external device (rewriting device) not shown and receives the indication information from the external device, the received indication information is stored in the indication information storage 142. The indication control circuit 143 controls the indication screen 141 in a manner to indicate indication contents (e.g., “abcde” shown in FIG. 3) defined by the indication information stored in the indication information storage 142. When the communication device 12 receives new indication information from the external device, the updating device 144 updates contents of the indication information stored in the indication information storage 142 to contents of the indication information received at the communication device 12. Thus, the indication control circuit 143 controls the indication screen 141 to indicate new indication contents instead of the previous indication contents.

In the wireless identification card 10 of the present embodiment, the power supply device 13 configured to energize the communication device 12 and the indication device 14 includes a solar cell 15 and a storage cell 16.

The solar cell 15 includes a solar cell panel (solar cell module) 151 being a photoelectric conversion element configured to convert optical energy into electrical energy, and an adjustment circuit 152 configured to adjust an output voltage of the solar cell panel 151 to a predetermined value (value suitable for operating the communication device 12 and the indication device 14). The solar cell module 151 is shaped into a plate shape. The solar cell module 151 is similar in size to the indication screen 141. The adjustment circuit 152 makes a maximum power point tracking control (MPPT control), for example. In contrast to use of a primary cell, use of the solar cell 15 does not require maintenance (e.g., battery exchange, and battery charge). Therefore, it is possible to successfully make stable power supply for a long time.

The storage cell 16 is a secondary cell or a capacitor. The storage cell 16 is adapted in use to supply electrical power to the communication device 12 and the indication device 14 under a condition where the solar cell 15 fails to receive sufficient light.

The power supply device 13 includes a charging circuit (not shown) configured to charge the storage cell 16 with electrical power output from the solar cell 15 in daytime where the solar cell 15 receives the sufficient light. In brief, the storage cell 16 is charged with the remaining electrical power (surplus power), i.e., the electrical power generated by the solar cell 15 minus the power consumed by the communication device 12 and the indication device 14. Further, the power supply device 13 includes a discharging circuit (not shown) configured to supply electrical power to the communication device 12 and the indication device 14 from the storage cell 16 when the solar cell 15 sees low electrical power generation. Therefore, even in nighttime where the solar cell 15 receives the insufficient light, the communication device 12 and the indication device 14 are energized. By using the storage cell 16, it is possible to use, in nighttime, electrical power which was generated by the solar cell 15 in daytime, thus enabling efficient use of the solar cell 15.

In order to generate sufficient electrical power by the solar cell 15 even in a house (room), the present embodiment employs the solar cell 15 including a material having sensitization action, an electron transport member, and a hole transport member. Each of the electron transport member and the hole transport member is configured to transfer electric charges.

Upon absorption of light, the sensitized material functions to distribute electrons (negative charges) and holes (positive charges) separately to different materials. This function causes a photoelectric conversion effect. The electron transport member (electron transport layer) receives the electrons from the material having the sensitization action, and the hole transport member (hole transport layer) receives the holes from the material having the sensitization action.

The material having the sensitization action is a dye or a quantum dot material, for example. The dye is selected from a ruthenium-cis-diaqua-bipyridyl complex of a RuL₂(H₂O)₂ type (herein, L represents 4,4′-dicarboxyl-2,2′-bipyridine), and transition metal complexes of types such as a ruthenium-tris (RuL₃) type, a ruthenium-bis (RuL₂) type, an osmium-tris (OsL₃) type and an osmium-bis (OsL₂) type. In addition, the dye can be selected from a zinc-tetra (4-carboxyphenyl) porphyrin, an iron hexacyanide complex, a phthalocyanine, a 9-phenylxanthene dye, a coumarin dye, an acridine dye, a triphenylmethane dye, a tetraphenylmethane dye, a quinone dye, an azo dye, an indigo dye, a cyanine dye, a merocyanine dye, and a xanthene dye, for example. The quantum dot material is selected from a PbS and CdS, for example.

A material of the electron transport member is preferred to be selected from oxidation products of metals (e.g., Cd, Zn, In, Pb, Mo, W, Sb, Bi, Cu, Hg, Ti, Ag, Mn, Fe, V, Sn, Zr, Sr, Ga, Si, and Cr), perovskites (e.g, SrTiO₃, and CaTiO₃), sulfides (e.g., CdS, ZnS, In₂S₃, PbS, Mo₂S, WS₂, Sb₂S₃, Bi₂S₃, ZnCdS₂, and Cu₂S), and metal chalcogenides (e.g., CdSe, In₂Se₃, WSe₂, HgSe, PbSe, and CdTe). In addition, the material of the electron transport member is preferred to be selected one from GaAs, Si, Se, Cd₃P₂, Zn₃P₂, InP, AgBr, PbI₂, HgI₂, and BiI₃. Further, the material of the electron transport member is preferred to be selected one from complexes including one or more kinds of materials selected from aforementioned semiconductor materials, such as, CdS/TiO₂, CdS/AgI, Ag₂S/AgI, CdS/ZnO, CdS/HgS, CdS/PbS, ZnO/ZnS, ZnO/ZnSe, CdS/HgS, CdSₓ/CdSe₁₋ₓ, CdSₓ/Te₁₋ₓ, CdSeₓ/Te₁₋ₓ, ZnS/CdSe, ZnSe/CdSe, CdS/ZnS, TiO₂/Cd₃P₂, CdS/CdSeCd_{y}Zn_{1-y}S, CdS/HgS/Cds. Besides, the material of the electron transport member is preferred to be selected from organic substances having an electron transport function, and n-type organic materials.

The hole transport member, although not limited by its kind, comprises a solvent which includes a pair of redox-reactive materials, one oxidant and the other reductant. The aforementioned redox-reactive materials are meant to denote a pair of materials in the forms of a reversible oxidant and a reversible reductant. The oxidant is defined as an oxidized electrolyte (e.g., I₃⁻), and the reductant is defined as a reduced electrolyte (e.g., I⁻). The hole transport member is selected from a material including p-type semiconductors (e.g., a copper iodide), amine derivatives (e.g., a triphenylamine), conducting polymers (e.g., a polyacetylene, a polyaniline, and a polythiophene), and p-type organic substances.

The solar cell including the material having the sensitization action and charge transport members (the electron transport member and the hole transport member) is a dye-sensitized solar cell, a quantum dot-sensitized solar cell, and a dye-sensitized organic solar cell, for example.

The solar cell 15 of the present embodiment is a dye-sensitized solar cell. As shown in FIG. 1B, the solar cell module 151 of the solar cell 15 includes a first substrate (working electrode substrate) 1511 made of a glass substrate, and a working electrode 1512 being a transparent electrical conductor layer (transparent electrode) which is formed over a surface (rear surface) of the first substrate. In addition, the solar cell module 151 of the solar cell 15 includes a second substrate (opposite electrode substrate) 1516 made of a glass substrate, and an opposite electrode 1515 being a transparent electrical conductor layer (transparent electrode) which is formed over a surface (front surface) of the second substrate. The first substrate 1511 and the second substrate 1516 are arranged such that the working electrode 1512 and the opposite electrode 1515 are faced to each other. Over the working electrode 1512 is formed a semiconductor layer 1513 made of a semiconductor. The semiconductor layer 1513 supports dyes (not shown) which emit electrons in response to reception of light. Further, the semiconductor layer 1513 functions as an electron transport member. Between the working electrode 1513 and the opposite electrode 1515 is interposed a sealing member 1517 which is shaped into a cylindrical shape to surround the semiconductor layer 1513. A space surrounded by the sealing member 1517 is filled with electrolysis solution forming an electrolyte layer 154 which functions as the hole transport member (reference document 1: Gratzel et al., “Nature” (GB), 1991.10.24, vol. 353, p. 737-740).

As described in the above, the solar cell 15 includes the semiconductor layer 1513, the working electrode 1512, the opposite electrode 1515, and the electrolyte layer 1514. The semiconductor layer 1513 supports the sensitizing material which is a dye configured to generate an electron and a hole in response to reception of light. The working electrode 1512 is formed over a first surface of the semiconductor layer 1513 in its thickness direction and configured to receive electrons from the sensitizing material. The opposite electrode 1515 is formed over a second surface of the semiconductor layer 1513 in its thickness direction. The electrolyte layer 1514 is interposed between the semiconductor layer 1512 and the opposite electrode 1515 and is configured to receive holes from the sensitizing material.

According to the above configuration, light (e.g., visible light) coming into the solar cell module 151 of the solar cell 15 is directed through the first substrate 1511 and the working electrode 1512, and is absorbed by the dye in the semiconductor layer 1513. Thus the dye is excited to emit electrons which move into the semiconductor layer 1513 and passes through a space between the semiconductor particles and reaches the working electrode 1512. After reaching the working electrode 1512, the electrons move to the opposite electrode 1515 through a load (e.g., the communication circuit 12) connected between the working electrode 1512 and the opposite electrode 1515 by way of conducting wires or the like. When receiving the electrons from the reduced electrolyte (reductant) I⁻ included in the electrolyte layer 1514, the dye returns back to a ground-level energy state from the excited energy state. The electrolyte (reductant) I⁻ is oxidized by the electrons supplied to the dye, and becomes the electrolyte (oxidant) I₃⁻. Upon receiving the electrons from the opposite electrode 1515, the oxidized electrolyte (oxidant) becomes the reductant I⁻. Thus, when the solar cell 15 receives the light, an electrical current is supplied from the solar cell 15 to the load (e.g, the communication device 12 and the indication device 14).

Besides, the first substrate 1511 and the second substrate 1516 made of a transparent material can give translucency to the solar cell module 151 of the solar cell 15. The first substrate 1511 and the second substrate 1516 made of a flexible plastic film can give flexibility to the solar cell module 151. Each of the working electrode 1512 and the opposite electrode 1515 is preferred to have high light transmittance. The light transmittance thereof is preferably equal to or more than 50%, and is more preferably equal to or more than 80%. The opposite electrode 1515 may be made of a fluorine doped tin oxide, for example. The semiconductor layer 1513 may be made of a porous film comprising minute particles of TiO₂, for example. With adopting TiO₂ as the semiconductor layer 1513, it is possible to prevent photodissolution of the semiconductor layer 1513 into the electrolyte layer 1514 and to improve photoelectric conversion performance.

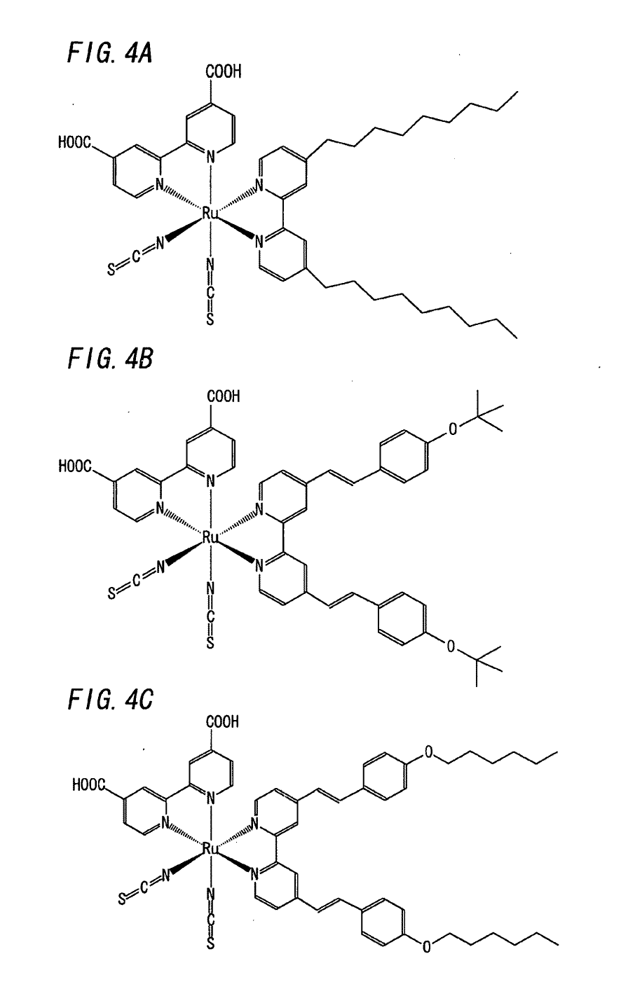

In the solar cell 15, an Ru complex is preferred to be adopted as the dye. Especially, it is preferred to use a high hydrophobic dye, such as K19 shown in FIG. 4A, K77 shown in FIG. 4B, and Z907 shown in FIG. 4C. With use of the highly hydrophobic dye, it is possible to prevent contact of the dye with water, and to suppress removal of the dye caused by hydrolysis. Therefore, durability of the solar cell 15 can be improved.

A concentration of the oxidant I₃⁻ included in the electrolyte layer 1514 is preferred not to exceed 0.02 mol/dm³, because the electrolyte layer 1514 having excessively high concentration of the oxidant absorbs visible light and causes a decrease in power generation efficiency of the solar cell 15.

Preferably, the concentration of the oxidant I₃⁻ has its lower limit of 10*10⁻⁹ mol/dm³. This concentration (10*10⁻⁹ mol/dm³) is identical to concentration of the oxidant I₃⁻ which is determined by measuring, base on an absorption photometry, the electrolyte layer 1514 which is made only by addition of a supply source (e.g., an iodide salt) of the reductant I⁻ to a solvent without the supply source (e.g., an iodine I₂) of the oxidant I₃⁻ being added to the solvent. The following two reasons explain that the concentration of the oxidant I₃⁻ is approximately 10*10⁻⁹ mol/dm³ regardless of no addition of the supply source of the oxidant I₃⁻ to the solvent. The first reason is that the oxidant I₃⁻ is produced from an impurity included in the iodide salt. The second reason is that some equilibration reaction caused by dissolution of the iodide salt in an organic solvent produces the oxidant I₃⁻.

A solvent adopted for the electrolyte layer 1514 is preferred to be selected one from a gamma-butyrolactone, a polyethylene glycol, a methoxypropionitrile solvent, and the like. Especially, the solvent of the electrolyte layer 1514 is preferred to be selected one from a gamma-butyrolactone, and a polyethylene glycol (molecular weight 200).

Further, the following examples 1 to 3 show a specific example of the solar cell 15.

### Example 1

In order to prepare the solar cell 15 of the example 1, first, a first paste used for screen printing is formed by dispersing high-purity titanium oxide powder having an average primary particle diameter of 20 nm into an ethyl cellulose. Further, a second paste used for screen printing is formed by dispersing high-purity titanium oxide powder having an average primary particle diameter of 20 nm and high-purity titanium oxide powder having an average primary particle diameter of 400 nm into an ethyl cellulose.

Next, the above first paste is applied, in a size of 1 cm by 3 cm, onto an electrically conductive glass substrate (available from Asahi glass Co., Ltd, a glass substrate to which electric conductivity is given by a surface coating of a fluorine doped SnO₂, surface resistance of 10 Ω/sq, thickness of 1 mm, size of 1.6 cm by 3.6 cm) used as the working electrode 1512 and the first substrate 1511, and subsequently is dried. After that, the dried first paste is baked in air at 500° C. over 30 minutes. Thereby, the porous titanium oxide film having a thickness of 10 μm is formed on the electrically conductive glass substrate. Further, the second paste is applied onto the porous titanium oxide film and is dried. Thereafter, the dried second paste is baked in air at 500° C. over 30 minutes. Thereby, the titanium oxide film having a thickness of 4 μm is formed on the porous titanium oxide film. Thus, the semiconductor layer having a light receiving area of 3 cm² can be obtained.

Next, the semiconductor layer 1513 is immersed in a solution including dyes (e.g., the dye shown in FIG. 4A). After that, the semiconductor layer 1513 is taken out from the solution, and is kept placed in a dark room at a room temperature over 24 hours. Thus, the dye is adsorbed into the semiconductor layer 1513. The aforementioned solution is prepared by dissolving the aforementioned dye into an equi-volume mixture by of an acetonitrile and a t-butanol to have a dye concentration of 3*10⁻⁴ mol/dm³.

H₂PtCl₆ solution (isopropyl alcohol) having a molar concentration of 5 mmol/dm³ is applied onto an electrically conductive glass substrate (available from Asahi glass Co., Ltd, a glass substrate having electric conductivity by a surface coating of a fluorine doped SnO₂, surface resistance of 10 Ω/sq, thickness of 1 mm, size of 1.6 cm by 3.6 cm) to have a volume per unit area of 5*10⁻⁶ l/cm², and is heated at 450° C. over 15 minutes. Thereby, the opposite electrode 1515 is formed on the second substrate 1516.

A thermoplastic resin (available from DuPont Co., Ltd. in the trade name of “Bynel®”) which has a thickness of 20 μm and is used as a basis for the sealing member 1517 is disposed between the first substrate 1511 and the second substrate 1516 to surround the semiconductor layer 1513. Thereafter, the thermoplastic resin is pressured in its thickness direction over 30 seconds while heated at 250° C. Thereby, the first substrate 1511 is bonded to the second substrate 1516 by the above thermoplastic resin.

Electrolysis solution is injected, by a depressurization injection method, into an inside of the sealing member 1517 (space between the first substrate 1511 and the second substrate 1516) via a 1 mm width hole formed in the sealing member. The electrolysis solution is prepared by dissolving a methyl tripropyl ammonium, an iodine, a lithium iodide, and an N-methylbenzimidazole into a gamma-butyrolactone to have 0.5 mol/dm³ molar concentration of the methyl tripropyl ammonium, 0.005 mol/dm³ molar concentration of the iodine, 0.05 mol/dm³ molar concentration of the lithium iodide, and 0.5 mol/dm³ molar concentration of the N-methylbenzimidazole.

### Example 2

The solar cell 15 of the example 2 is different from the solar cell 15 of the example 1 in that electrolysis solution prepared by dissolving iodine to have molar concentration of 0.05 mol/dm³ for the iodine is adopted as the electrolyte layer 1514, and the other is similar to the solar cell 15 of the example 1.

### Example 3

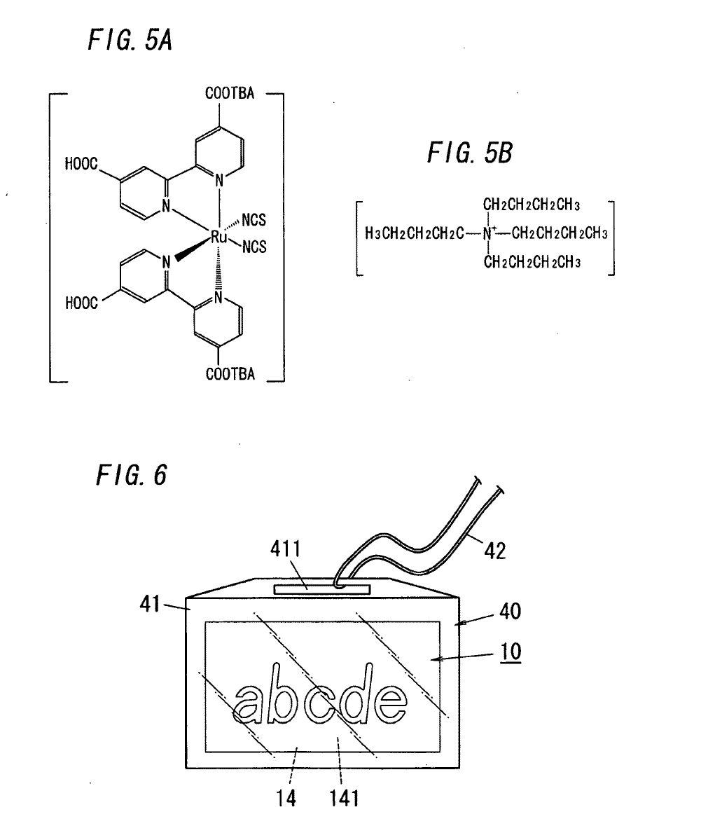

The solar cell 15 of the example 3 is different from the solar cell 15 of the example 1 in that the dye shown in FIG. 5A is adopted, and the other is similar to the solar cell 15 of the example 1. Besides, “TBA” in FIG. 5A denotes a tetrabutylammonium illustrated in FIG. 5B.

With use of the solar cell 15 of each example described in the above, it is possible to generate electric power which is sufficient to operate the communication device 12 and the indication device 14 not only out of doors but also in doors (in a room). Therefore, the solar cell 15 can alone supply electrical power required to communication between the wireless identification card 10 and the reading device 90 or the like.

In a situation where an active type wireless identification card (including no indication device 14) with a lithium battery CR2032 (button-shaped battery) is applied to the aforementioned contactless identification system, it is reported that a battery life of the wireless identification card is approximately 1 year under a normal use condition. According to a relation of the battery capacity to the battery life, consumed power per day is approximately 1.8 mWh/day. The following table 1 shows results of verification made to each example for evaluation whether or not the solar cell 15 can cover the above consumed power. In the verification, it is supposed that the solar cell is used in doors (room), and that a light source is a fluorescent light. A light receiving amount per day is defined as a light receiving amount of the solar cell when the solar cell 15 is placed over 6 hours under illuminance of 100 lx. The light receiving area of the solar cell 15 is defined as 10 cm². Further, similar verification was made to a silicon solar cell (crystalline silicon solar cell) as a comparative example.

TABLE

| | electrical power generation per day |
|---|---|
| kinds of solar | of solar cell having size of 10 cm² |
| cells | (mWh/day) |
| comparative | 0.09 |
| example 1 | |
| example 1 | 2.4 |
| example 2 | 2.0 |
| example 3 | 2.0 |

The comparative example 1 can not supplement consumed power per day (1.8 mWh/day) of the wireless identification card 10. Therefore, the solar cell according to the comparative example 1 needs to be used in cooperation with a primary cell, and a battery life of the solar cell can be prolonged by an extent corresponding to 0.09 mWh/day. The silicone solar cell sees low power generation efficiency under a low illumination environment, and has low sensitivity for light within a particular wavelength band (e.g., light emitted from a fluorescent lamp).

In contrast, each of the examples 1 to 3 has generation power per day which exceeds the consumed power per day (1.8 mWh/day) of the wireless identification card 10. Therefore, the electrical power generated by the solar cell 15 can alone supplement the power of the wireless identification card 10. Accordingly, the wireless identification card 10 of the present embodiment can be used successively without maintenance (e.g., battery exchange).

Further, as shown in FIGS. 3A and 3B, the wireless identification card 10 includes the main body 20 to hold the identification information storage 11, the communication device 12, and the storage cell 16.

The main body 20 is made of a dielectric plastic material, and is shaped into a card shape having dimensions proper to carry by a user. The main body 20 has the substantially same dimensions as the solar cell module 151 and the indication screen 141. The main body 20 is configured to incorporate a mounting substrate (not shown). On the mounting substrate are mounted the identification information storage 11, the communication device 12, and the storage cell 16. Moreover, on the mounting substrate are mounted the indication information storage 142, the indication control circuit 143, and the updating device 144 of the indication device 14.

Over a front surface of the main body 20 are disposed the indication screen 141 of the indication device 14 and the solar cell module 151 of the solar cell 15. The indication screen 141 is disposed over the front surface of the main body 20 such that the solar cell module 151 is interposed between the indication screen 141 and the front surface of the main body 20. In brief, the indication screen 141 of the indication device 14 is disposed on a front surface of the solar cell module 151 of the solar cell 15.

The adjustment circuit 152 of the solar cell 15 mounted on the mounting substrate of the main body 20 and the solar cell module 151 disposed over the front surface of the main body 20 are connected to each other by way of a proper line (not shown) such as one of various cables (e.g., a flexible cable), a terminal, and a patterned conductor. Additionally, the indication information storage 142, the indication control circuit 143, and the updating device 144 mounted on the mounting substrate of the main body 20 and the indication screen 141 disposed over the front surface of the main body 20 are connected to each other by use of a proper line (not shown) such as one of various cables (e.g., a flexible cable), a terminal, and a patterned conductor. Further, the power supply device 13 and the indication device 14 are connected to each other by use of a proper line (not shown) such as one of various cables (e.g., a flexible cable).

Besides, the adjustment circuit 152 of the solar cell 15, and the indication information storage 142, the indication control circuit 143, and the updating device 144 of the indication device 14 need not be mounted on the mounting substrate of the main body 20. The adjustment circuit 152 may be integrated with the solar cell module 151. Further, the indication information storage 142, the indication control circuit 143, and the updating device 144 may be integrated with the indication screen 141.

Further, the wireless identification card 10 of the present embodiment includes a diffusion transmission member (diffusion transmission layer) 30 interposed between the indication screen 141 of the indication device 14 and the solar cell module 151 of the solar cell 15.

The diffusion transmission member 30 is configured to, upon receiving light, diffuse the light used for visual indication by the indication unit 14 (the light used in the indication part 1411), and transmit the light used for electrical generation of the solar cell 15. For example, the diffusion transmission member 30 is a panel (opalescent panel) in the form of a panel made of an opalescent plastic material having translucency.

As mentioned in the above, in the wireless identification card 10, the indication device 14 (indication screen 141), the diffusion transmission member 30, the solar cell 15 (solar cell module 151), and the main body 20 are laminated in this order from a front side of the wireless identification card 10.

Accordingly, the light coming into the wireless identification card 10 from a visible side (front side) thereof is directed through the indication screen 141 of the indication device 14 having translucency and reaches the diffusion transmission member 30. A part of the light which reached the diffusion transmission member 30 is diffused by the diffusion transmission member 30, and the rest is directed through the diffusion transmission member 30 and reaches the solar cell module 151 of the solar cell 15.

The wireless identification card 10 of the present embodiment can improve the electrical power generation under the low illumination environment (e.g. in doors) in contrast to the wireless identification card employing a general crystalline silicon solar cell. Therefore, even if the wireless identification card 10 is frequently used indoors, it is possible to supplement consumed power by use of only the solar cell 15 of limited dimensions. Further, it is possible to reduce a production cost of the solar cell 15. As described in the above, since the solar cell 15 energizes the communication device 12 and the indication device 14, the maintenance (e.g., battery exchange) is unnecessary.

Further, in the wireless identification card 10, the indication device 14 and the solar cell 15 are attached to the front surface of the main body 20 such that the indication device 14 is superimposed on the solar cell 15 in a forward/rearward direction. Therefore, in contrast to a prior art in which the solar cell 15 and the indication device 14 are arranged in parallel in the same plane (the front surface of the main body 20), it is possible to enlarge the surface area of each of the solar cell 15 and the indication device 14. Accordingly, it is possible to improve the visibility of the indication device 14 and the electrical power generation of the solar cell 15. Further, it is possible to increase an amount of information which is displayed on the indication screen 141 at a time.

Since a part of the light passing through the indication device 14 is diffused by the diffusion transmission member 30, the visibility of the visual indication of the indication device 14 can be improved. Further, the solar cell 15 generates electric power by use of the light which is directed through the diffusion transmission member 30. Therefore, the incoming light from one side (front side) enables both the visual indication by the indication device 14 and the generation of electric power by the solar cell 15.

Further, since the indication information storage 142 stores the indication information received from the external device, the visual indication is kept indicated even if the communication with the external device is completed. Therefore, the wireless identification card need not communicate with the external device many times in order to indicate the same visual indication. In addition, upon receiving the indication information different in contents from the present indication information, the wireless identification card 10 makes the visual indication based on the received indication information. In brief, it is possible to update, in response to reception of new indication contents, current indication contents to the new indication contents.

In the indication device 14, the indication screen 141 may be configured to hold the indication contents by keep indicating the same indication contents. That is, the indication screen 141 may be configured to function as the indication information storage 142. The above indication screen 141 may be an electronic paper. The electronic paper can make successive visual indication without power supply. Therefore, with adopting the electronic paper as the indication screen 141, it is possible to keep indicating the visual indication even if the communication with the external device is completed. Therefore, the wireless identification card need not communicate with the external device many times in order to indicate the same visual indication. Further, since the electronic paper can keep making the visual indication even if power supply thereto is terminated, it is possible to reduce consumed power. Besides, a memory-effect liquid crystal panel (e.g., a cholesteric liquid crystal) can be used instead of the electronic paper.

In the above wireless identification card 10, the indication device 14 which can change the visual indication is adopted as the indication unit. However, as the indication unit is adopted a visual indication plate. The visual indication plate is a printed material prepared by printing visual information destined to be transmitted such as letters and graphics (e.g., “abcde”) on a surface of a paper or a resin molded article. When the indication plate is used instead of the indication device 14, it is unnecessary to supply electrical power from the solar cell 15 and/or the storage cell 16.

In the wireless identification card 10 of the present embodiment, the solar cell 15 is adopted as the power source. Thus, a user is required to carry the wireless identification card 10 such that the solar cell 15 receives light because any solar cell 15 cannot generate sufficient power in a situation where the wireless identification card 10 cannot receive sufficient light (e.g, a situation where the wireless identification card 10 is placed in a pocket of clothes, a bag, and a drawer). However, if the solar cell 15 of the wireless identification card 10 should force the user to orient it in a direction of receiving the light, it would greatly hamper convenience of an active tag which is inherently unnecessary to hold the wireless identification card 10 over the reading device 90. Thus, in order to use effectively, as the power source, the solar cell 15 mounted on the wireless identification card 10, the solar cell 15 is preferred to receive light in a normal use of the wireless identification card 10.

In view of the above, as shown in FIG. 6, the wireless identification card 10 is preferred to be applied to a name tag 40, for example.

In the wireless identification card 10, the indication device 14 and the solar cell 15 are disposed over the front surface of the main body 20. Thus, when a user carries the wireless identification card 10 such that the indication screen 141 of the indication device 14 is easily visible to people around (when a user carries the wireless identification card 10 so as to show the indication device 14 to people around), light coming into the indication device 14 is directed through the indication device 14 and the diffusion transmission member 30 and reaches the solar cell 15. Consequently, the solar cell of the wireless identification card 10 can successfully receive the light without a particular need of being oriented towards the light.

When the wireless identification card 10 is adopted as the name tag 40, the indication contents of the indication screen 141 is an owner's name, and/or an owner's position (a department name), for example. If the owner or the owner's position is changed, the new indication information is transmitted from the external device to the wireless identification card 10 to update the indication contents of the indication screen 141.

In this arrangement, in view of portability, a thickness of the wireless identification card 10 is preferred not to exceed 10 mm. Especially, in view of attaching it to clothes, the thickness of the wireless identification card 10 is preferred not to exceed 5 mm. Further, in view of the same usability (portability) as that of a nameplate of a conventional name tag or a credit card, the thickness of the wireless identification card 10 is preferred not to exceed 2 mm. In view of carrying it long time, a weight of the wireless identification card 10 is preferred not to exceed 200 g. In view of attaching it to clothes, the weight of the wireless identification card 10 is preferred not to exceed 100 g.

The name tag 40 includes a case 41 in the form of a flat plate made of a transparent material and is configured to house the wireless identification card 10. The case 41 is provided at its upper end with a through hole 411 adapted in use to pass a neck strap (cord) 42 which is used for dangling the case 41 from one's neck.

Accordingly, the user can wear the neck strap 42 around one's neck to carry the wireless identification card 10 by dangling the same from one's neck. In this situation, the wireless identification card 10 is disposed on the user's clothes. Besides, the wireless identification card 10 need not be dangled from one's neck by use of the neck strap 42. For example, the wireless identification card 10 may be attached to the user's clothes by use of a pin, a hook, or a cord. The wireless identification card 10 may be fixed to the user's clothes by use of integrating the wireless identification card 10 with the user's clothes, of sticking the wireless identification card 10 on the user's clothes, or of sewing the wireless identification card 10 on the user's clothes.

As described in the above, with controlling the indication device 14 to indicate a user's name, the user's position (department name), and/or the like, the wireless identification card 10 can be used as a name tag. In addition, the indication device 14 can be easy to change its indication contents each change in an owner or owner's post. The name tag employing the wireless identification card 10 is more convenient than a paper name tag. Especially, in a situation the name tag is used as a guest's name tag, the name tag employing the wireless identification card 10 is more convenient than a paper name tag because “name” as the indication contents is easily changed in association with a guest.

Besides, the wireless identification card 10 may be applied to a shoulder mark, an arm badge, a cross brace, a badge, a tag, and the like.

Alternatively, the wireless identification card 10 is used in a terminal for explanation of an exhibit in a gallery or a museum, for example.

In the past, an explanation to an exhibit is described on a front surface of an explanation panel which is placed on a wall in a vicinity of the exhibit, for example. Therefore, a visitor has to come in front of the explanation panel to read the explanation to the exhibit. However, when many visitors are in a museum (when a museum is crowded), it is difficult for a visitor to come in front of the explanation panel to read the explanation.

The above problem can be solved by use of the wireless identification card 10 as a terminal for an explanation to an exhibit. First, a visitor receives the wireless identification card 10 when entering the museum. Above the exhibit is disposed an external device which is configured to transmit the visual indication information having the indication contents defining an explanation to the corresponding exhibit. Consequently, when the visitor comes close to the exhibit in the museum, the wireless identification card 10 carried by the visitor receives the visual indication information from the external device, and controls the indication screen 141 to display the indication contents (explanation to the exhibit) defined by the received visual indication information. When the visitor comes close to another exhibit, the wireless identification card 10 receives the visual indication information from another external device, and controls the indication screen 141 to display the indication contents (explanation to another exhibit) defined by the received visual indication information.

Therefore, with use of the wireless identification card 10, a visitor can easily read the explanation to the exhibit in contrast to use of the explanation panel.

The aforementioned wireless identification card 10 may be applied to the contactless identification system which requires personal authentication to activate an engine of a car, a computer, various equipment devices, or the like. For example, in a situation where the reading device 90 is placed at an entrance of a managed area with an unspecified number of visitors, and only an authorized visitor (who has an appointment) is given the wireless identification card 10 in advance, it is possible to identify the authorized user and allow the same to enter the managed area, independently of whether they are acquainted. In a situation where an act in a group is required in a care facility, a school, a company, a group tour, or the like, with providing the wireless identification card 10 to each person, it is possible to check existence for each person without calling over.

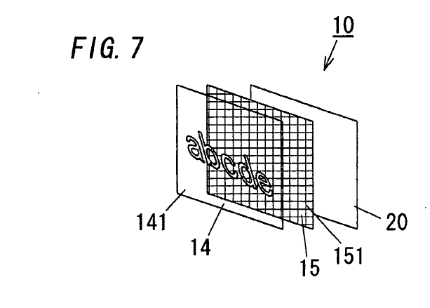

FIG. 7 shows a modification of the wireless identification card 10 of the present embodiment. The modification illustrated in FIG. 7 includes no diffusion transmission member 30. In brief, in a situation where the wireless identification card 10 devoid of the diffusion transmission member 30 has the enough visibility of the indication device 14, the wireless identification card 10 need not be provided with the diffusion transmission member 30.

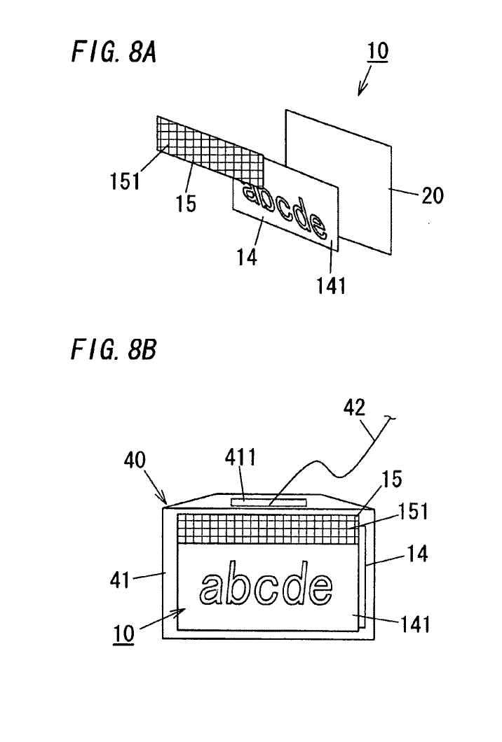

FIGS. 8A and 8B show a modification of the wireless identification card 10 of the present embodiment. In the modification illustrated in FIGS. 8A and 8B, the solar cell 15 and the indication device 14 are arranged in a common plane (on the front surface of the main body 20).

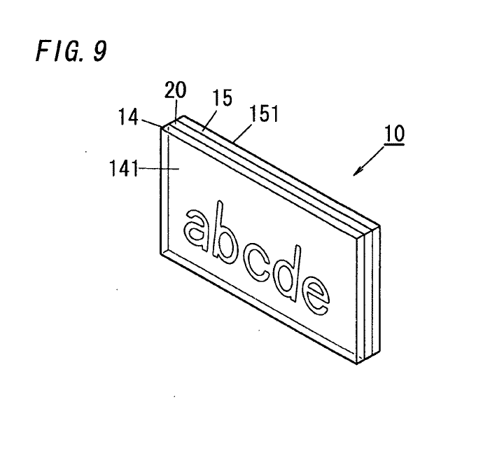

FIG. 9 shows a modification of the wireless identification card 10 of the present embodiment. In the modification illustrated in FIG. 9, the indication screen 141 of the indication device 14 is disposed on the front surface of the main body, and the solar cell module 151 of the solar cell 15 is disposed on a rear surface of the main body 20. In this modification, the solar cell 15 generates electric power by use of light coming from a rear side of the wireless identification card 10.

### Second Embodiment

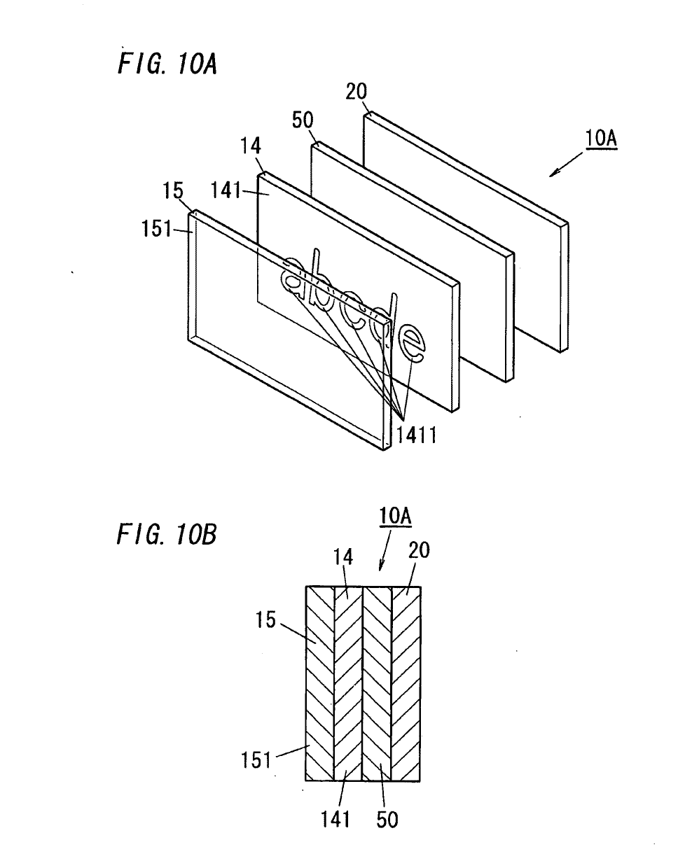

As shown in FIGS. 10A and 10B, the wireless identification card 10A is different from the wireless identification card 10 of the first embodiment in that the solar cell 15, the indication device 14, and a background plate 50 are arranged over the front surface of the main body 20. Besides, components common to the wireless identification card 10A of the present embodiment and the wireless identification card 10 of the first embodiment are designated by the same reference numerals and no explanations thereof are deemed necessary.

The solar cell 15 (solar cell module 151) is disposed over the front surface of the main body 20 such that the indication unit 14 (indication screen 141) is interposed between the solar cell 15 and the main body 20. In brief, the solar cell 15 is disposed over a front surface of the indication device 14. Further, between the indication device 14 and the main body 20 is disposed the background plate (background layer) 50 (the background plate 50 is disposed over a rear surface of the indication screen 141 of the indication device 14). In the wireless identification card 10A, the solar cell 15, the indication device 14, the background plate 50, and the main body 20 are laminated in this order from the front side of the wireless identification card 10A.

As described in the above, the solar cell 15 is the dye-sensitized solar cell. The dye-sensitized solar cell can be formed to have translucency for visible light. In the present embodiment, the solar cell module 151 of the solar cell 15 has translucency for visible light (the solar cell module 151 of the solar cell 15 is transparent). It is sufficient that the solar cell module 151 has transparency which is enough for a user to definitely view the visual indication of the indication device 14 through the solar cell 15. The solar cell module 151 need not be configured not to absorb any visible light but to transmit all the visible light. That is, the solar cell module 151 may be configured to absorb a part of the visible light to generate electric power and to allow a user to definitely view the visual indication by the indication screen 141 of the indication device 14 through the solar cell module 151. Therefore, the solar cell module 151 is not limited to be colorless and transparent, but may be colored and transparent. Further, the solar cell module 151 may have slight light diffuseness.

The background plate 50 is a white plate, for example. The background plate 50 diffuses light passing through the solar cell 15 (solar cell module 151) and the indication device 14 (indication screen 141). Therefore, the background plate 50 functions as a reflective plate (reflective layer) configured to reflect, toward the indication device 14, the light passing through the solar cell module 151 and the indication screen 141. Additionally, the background plate 50 defines a background color of the indication device 14 and improves the visibility of the visual indication by the indication device 14.

Preferably, a contrast between the indication part 1411 of the indication screen 141 of the indication device 14 and the background plate 50 is not to less than 0.1. The contrast C10 is represented by the following formula (1).

$$\begin{matrix}[ FORMULA ] & \\ C 10 = \frac{L 10 - L 11}{L 10} & ( 1 )\end{matrix}$$

L10 denotes luminance (cd/m²) of the indication part 1411, and L11 denotes luminance (cd/m²) of the background plate 50.

Light (incoming light) coming into the wireless identification card 10A from the visible side (front side) reaches the solar cell 15. The solar cell 15 converts energy of light of a particular wavelength (wavelength of light which the dye absorbs) included in the incoming light into electrical energy, thereby generating electrical power. The incoming light which was directed through the solar cell module 151 of the solar cell 15 passes further through the indication screen 141 of the indication device 14 and reaches the background plate 50. The light which reached the background plate 50 is reflected by the background plate 50, and passes through the indication screen 141 of the indication device 14 again and finally reaches the solar cell module 151 of the solar cell 15. The solar cell 15 converts energy of the light reflected by the background plate 50 into electric energy, thereby generating electric power.

According to the aforementioned wireless identification card 10A of the present embodiment, since the solar cell 15 is disposed in front of the indication device 14, the solar module 15 easily receives light in contrast to an instance where the solar cell 15 is disposed in back of the indication device 14. Therefore, the electrical power generation of the solar cell 15 (an amount of electrical power generated by the solar cell 15) can be increased. Further, the background plate 50 reflects light passing through the solar cell 15 and the indication device 14 to come into the solar cell 15 again. Thus, the solar cell 15 can make photoelectric conversion by use of light (reflection light) reflected by the background plate (reflective plate) 50 in addition to light (incoming light) which directly comes into the solar cell 15. As a result, the electrical power generation of the solar cell 15 can be increased. In addition, it is possible to improve the visibility of the visual indication (the indication part 1411 of the indication screen 141) of the indication device 14. Accordingly, the indication device 14 gives at its indication screen 141 the visual indication which is easily recognized even when it is viewed from a distance.

Besides, the background plate 50 is not limited to the white plate, but may be a plate having its surface painted white. A color of the background plate 50 is not limited to white, but may be a color which makes the contrast C10 be not less than 0.1.

For example, the color of the background plate 50 may be a complementary color which is complementary to a color of the indication part 1411 of the indication screen 141. For example, when the color of the indication part 1411 is red, aqua is selected as the color of the background color 50. When the color of the indication part 1411 is yellow, blue is selected as the color of the background color 50. In brief, a color which is precisely complementary in the hue circle to the color of the indication part 1411 can be selected as the color of the background plate 50. As described in the above, with selecting the color of the indication part 1411 and the color of the background 50 to be complementary to each other, it is possible to improve the visibility of the indication part 1411 of the indication screen 141, and the indication device 14 gives at its indication screen 141 the visual indication which is easily recognized even when it is viewed from a distance. Besides, the color of the background plate 50 need not be a color which is precisely complementary in the hue circle to the color of the indication part 1411, but may be a color which is regarded to be approximately complementary in the hue circle to the color of the indication part 1411.

The background plate 50 may be defined as a regressive reflection plate configured to reflect incoming light to a direction opposite to a direction in which the light comes into the regressive reflection plate. The regressive reflection plate can be made by forming a predetermined concavo-convex structure in a surface of a metal plate.

With this arrangement, light which was directed through the solar cell 15 and the indication device 14 and reached the background plate 50 is reflected to the direction opposite to the incoming direction by the background plate 50.

Accordingly, in contrast to a situation where light is diffused by the background plate 50, the indication screen 141 of the indication device 14 can be brightened. Thus, the indication device 14 can have the improved visibility and is therefore easily recognized even from a distance.

### Third Embodiment

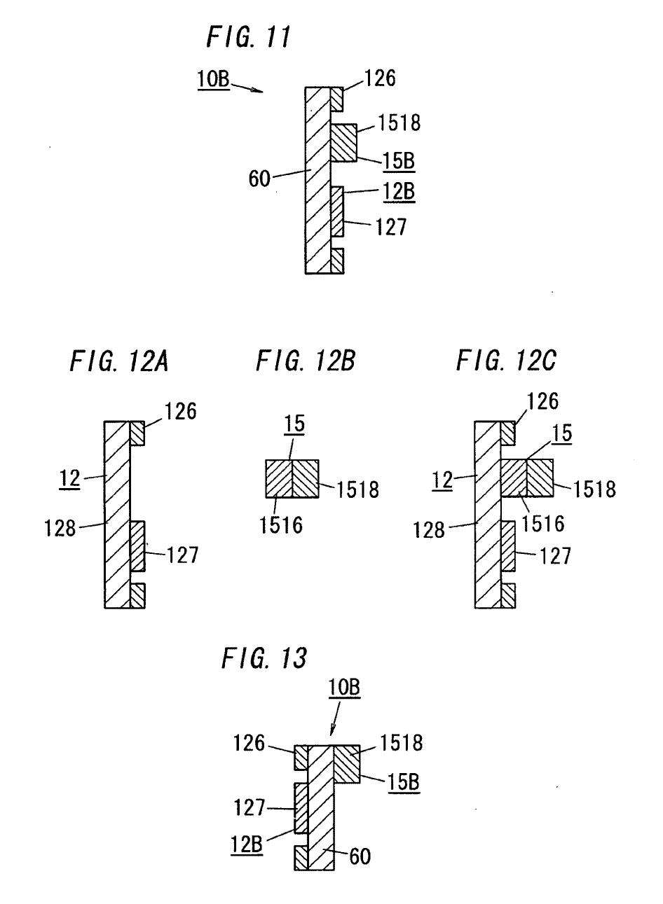

As shown in FIG. 11, the wireless identification card 10B of the present embodiment is characterized in configurations of the communication device 12B and the solar cell 15B. The other configurations of the wireless identification card 10B are the same as those of the wireless identification card 10 of the first embodiment, and are designated by the same reference numerals, and no explanations thereof are deemed necessary.

FIGS. 12A to 12C show a reference example for the wireless identification card 10B of the present embodiment.

The communication device 12 illustrated in FIG. 12A includes a first base (substrate) 128 shaped into a rectangular shape, an antenna 126 formed on a first surface (front surface) of the first base 128, and a communication circuit 127 formed on the first surface of the first base 128. The antenna 126 is formed in a circular pattern along an outer periphery of the first base plate 128, for example. The antenna 126 defines the above LF antenna 121 and RF antenna 123. The communication circuit 127 is a circuit configured to communicate with the reading device 90 by use of the antenna 126, and defines the above LF reception circuit 122, RF communication circuit 124, and communication control circuit 125.

The solar cell 15 illustrated in FIG. 12B comprises the opposite electrode substrate 1516 defined as a second base plate shaped into a rectangular shape, and a photoelectric conversion member (photoelectric conversion layer) 1518. The photoelectric conversion member 1518 is defined by the working electrode substrate 1511, the working electrode 1512, the semiconductor layer 1513, the electrolyte layer 1514, the opposite electrode 1515, and the sealing material 1517.

In a situation where the solar cell 15 is arranged in front of the communication device 12, the second base plate 1516 of the solar cell 15 is fixed to the first surface of the first base plate 128 of the communication circuit 12, as shown in FIG. 12C. With this arrangement, the thickness of the wireless identification card 10 is increased in contrast to a situation where the wireless identification card 10 is devoid of the solar cell 15. Besides, when the second base plate 1516 of the solar cell 15 is placed on the first surface of the first base plate 128 in a manner not to overlap with the communication circuit 127 and the antenna 126, as shown in FIG. 12C, the provision of the solar cell 15 only leaves a slight increase of the thickness of the wireless identification card 10. However, a thickness of a laminate of the solar cell 15 and the communication device 12 always exceeds a total thickness of the first base plate 128, the second base plate 1516, and the photoelectric conversion member 1518.

FIG. 11 shows the communication device 12B and the solar cell 15B of the wireless identification card 10B of the present embodiment. The wireless identification card 10B includes a base plate (common base plate) used in both the solar cell 15B and the communication device 12B. The common base plate 60 is a substrate (the mounting substrate of the main body 20, as mentioned in the above), for example. The communication device 12B is defined by the common base substrate 60, the antenna 126 formed on the common base plate 60 (a front surface of the common base plate 60), and the communication circuit 127 formed on the common base plate 60 (the front surface of the common base plate 60). The solar cell 15B is defined by the common base plate 60, and the photoelectric conversion member 1518 formed on the common base plate 60 (the front surface of the common base plate 60).

According to the wireless identification card 10B, the common base plate 60 is used as both the first base plate 128 of the communication device 12 and the second base plate 1516 of the solar cell 15. Therefore, the wireless identification card 10B of the present need not be provided with the second base plate 1516 of the solar cell 15. In other words, in the instance shown in FIG. 11, the common base plate 60 is shared by both the solar cell 15B and the communication device 12B. Therefore, the laminate (illustrated in FIG. 11) of the solar cell 15B and the communication device 12B is thinner than the laminate (illustrated in FIG. 12C) of the solar cell 15 and the communication device 12 by an extent of a thickness of the second base plate 1516 of the solar cell 15B.

The aforementioned wireless identification card 10B includes the common base plate 60 used as both a structural member (second base plate 1516) of the solar cell 15B and a structural member (first base plate 128) of a component (communication device 12B) other than the solar cell 15. Therefore, it is possible to thin the wireless identification card 10B. Further, in the present embodiment, the photoelectric conversion member 1518, the antenna 126, and the communication circuit 127 are formed over the front surface (first surface of the common base plate 60 in its thickness direction) of the common base plate 60. Thus, the other components (e.g., the storage cell 16 and the identification information storage 12 not shown) can be formed over the rear surface (second surface of the common base plate 60 in its thickness direction) of the common base plate 60. In contrast to the wireless identification card in which the photoelectric conversion member 1518, the antenna 126, and the communication circuit 127 are formed over the different surfaces of the common base plate 60, it is possible to thin the wireless identification card 10B.

FIG. 13 shows a modification of the wireless identification card 10B of the present embodiment. In the modification shown in FIG. 13, the photoelectric conversion member 1518 is formed over the front surface of the common base plate 60, and the antenna 126 and the communication circuit 127 are formed over the rear surface of the common base plate 60.

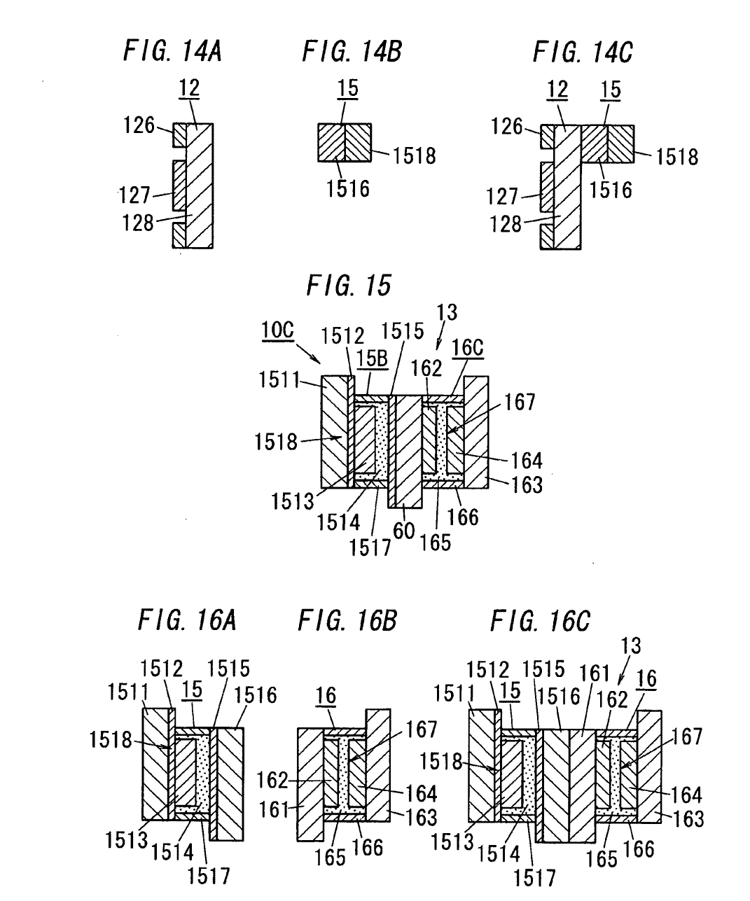

With the modification shown in FIG. 13, the photoelectric conversion member 1518 is formed over one surface of the common base plate 60, and the antenna 126 and the communication circuit 127 are formed on the other surface of the common base plate 60. Thus, in contrast to the wireless identification card in which the photoelectric conversion member 1518, the antenna 126, and the communication circuit 127 are formed over the same surface of the common base plate 60, it is possible to decrease in size the wireless identification card 10B (a size of the common base plate 60). In brief, the surface (rear surface) of the common base plate 60 over which the antenna 126 and the communication circuit 127 are formed need not be provided with a space for forming the photoelectric conversion member 1518 of the solar cell 12B. Consequently, it is possible to downsize the common base plate 60. Accordingly, the wireless identification card 10B can be downsized. Further, as shown in FIGS. 14A to 14C, in contrast to a situation where the solar cell 15 and the communication device 12 are provided with the dedicated base plates 1516 and 128, respectively, it is possible to thin the laminate of the solar cell 15B and the communication device 12B.

Besides, in the wireless identification card 10B, a structural member of the solar cell 15 may be used as a structural member of the identification information storage 11. Alternatively, a structural member of the solar cell 15 may be used as both a structural member of the communication device 12 and a structural member of the identification information storage 11. With these arrangements, the wireless identification card 10B can be thinned.

### Fourth Embodiment

As shown in FIG. 15, the wireless identification card 10C of the present embodiment is characterized in the configurations of the solar cell 15B and the storage cell 16C. The configurations common to the wireless identification card 10C of the present embodiment and the wireless identification cards 10 and 10B of the other embodiments are designated by the same reference numerals, and no explanations thereof are deemed necessary.

FIG. 16 shows a reference example of the wireless identification card 10C of the present embodiment.

The solar cell 15 shown in FIG. 16A includes the opposite substrate 1516 and the photoelectric conversion member 1518. The opposite substrate 1516 is defined as the second base plate shaped into a rectangular shape.

The storage cell 16 shown in FIG. 16B includes a positive electrode base plate (positive electrode substrate) 161 in the form of a rectangular plate, and a first electric conductive layer (positive electrode) 162 formed on a first surface of the positive electrode substrate 161. Further, the storage cell 16 includes a negative electrode base plate (negative electrode substrate) 163 in the form of a rectangular plate, and a second electric conductive layer (negative electrode) 164 formed on a first surface of the negative electrode substrate 163. The positive electrode substrate 161 and the negative electrode substrate 163 are arranged such that the positive electrode 162 and the negative electrode 164 are faced to each other. Between the positive electrode substrate 161 and the negative electrode substrate 163 is disposed a sealing material 166 which is shaped into a cylindrical shape and is configured to surround the positive electrode 162 and the negative electrode 164. A space surrounded by the sealing member 166 is filled with an electrolysis solution.

As shown in FIG. 16C, when the solar cell 15 are simply superimposed on the storage cell 16, a thickness of the laminate of the solar cell 15 and the storage cell 16 is equal to a sum of the thickness of the solar cell 16 and the thickness of the storage cell 16.

FIG. 15 shows the solar cell 15B and the storage cell 16C of the wireless identification card 10C of the present embodiment. The wireless identification card 10C includes the base plate (common base plate) 60 shared by both the solar cell 15B and the storage cell 16C. The solar cell 15B are defined by the common base plate 60 together with the photoelectric conversion member 1518 formed on the common base plate 60 (the front surface of the common base plate 60). The storage cell 16C are defined by the common base plate 60 together with a storage cell member (storage cell layer) 167 formed on the common base plate 60 (the rear surface of the common base plate 60). The storage cell member 167 is defined by the first electric conductive layer 162, the negative electrode base plate 163, the second electric conductive layer 164, the electrolysis solution 165, and the sealing member 166.

As described in the above, in the wireless identification card 10C of the present embodiment, the common base plate 60 is used as both the positive electrode base plate 161 of the storage cell 16 and the second base plate 1516 of the solar cell 15. In other words, in the instance shown in FIG. 15, the solar cell 15B and the storage cell 16C share the common base plate 60. Thus, a laminate (illustrated in FIG. 15) of the solar cell 15B and the storage cell 16C is thinner than a laminate (illustrated in FIG. 16C) of the solar cell 15 and the storage cell 16.

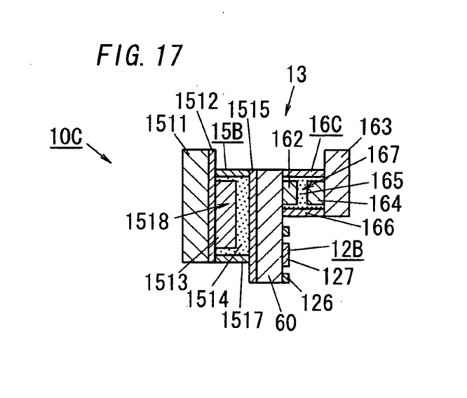

FIG. 17 shows a modification of the present embodiment. In FIG. 17, the antenna 126 and the communication circuit 127 are formed over the rear surface of the common base plate 60. The communication device 12B is defined by the common base plate 60, the antenna 126, and the communication circuit 127. In other words, the solar cell 15B, the storage cell 16C, and the communication device 12B share the common base plate 60. Thus, it is possible to further thin the wireless identification card 10C.

Besides, the common base plate 60 may have transparent.

### Fifth Embodiment

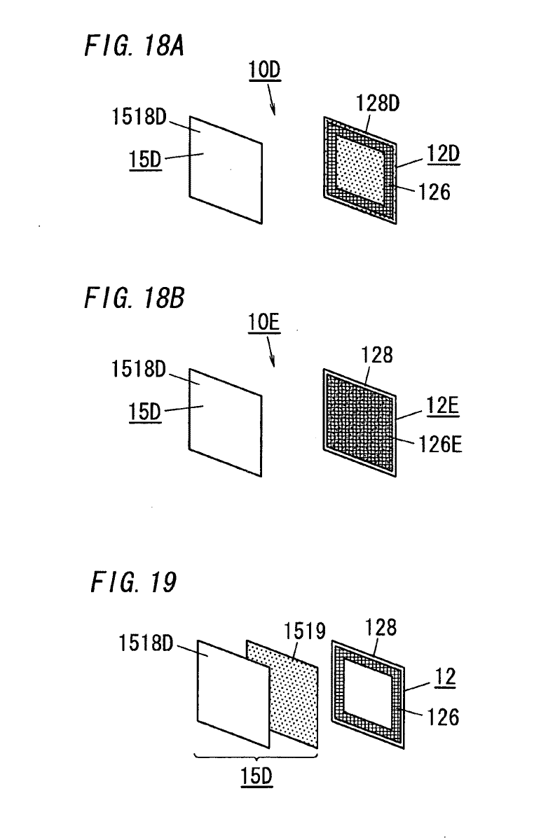

As shown in FIG. 18A, the wireless identification card 10D of the present embodiment is characterized in the configurations of the communication device 12D and the solar cell 15D. The configurations common to the wireless identification card 10D of the present embodiment and the wireless identification cards 10, 10A to 10C of the other embodiments are designated by the same reference numerals, and no explanations thereof are deemed necessary.

The solar cell 15D includes the photoelectric conversion member 1518D defined as a cell body which has translucency and is configured to convert optical energy into electric energy. The photoelectric conversion member 1518D is defined by the first substrate 1511, the working electrode 1512, the semiconductor layer 1513, the electrolyte layer 1514, the opposite electrode 1515, the second substrate 1516, and the sealing member 1517. In addition, the photoelectric conversion member 1518D is shaped into a rectangular shape and has a size same as that of the base plate 128 of the communication device 12.

The photoelectric conversion member 1518D is configured to have translucency for visible light. In this situation, it may occur that the light, which is incident on the photoelectric conversion member 1518D from a front surface thereof, passes through the photoelectric conversion member 1518D, and is directed out from a rear surface of the photoelectric conversion member 1518D. Therefore, as shown in a reference example of FIG. 19, it is preferred to dispose a reflector (reflective layer) 1519 in back of the photoelectric conversion member 1518D. The reflector 1519 is configured to reflect, to the photoelectric conversion member 1518D, light which passed through the photoelectric conversion member 1518D. In brief, the solar cell 15D is preferred to be provided with the photoelectric conversion member 1518D and the reflector 1519.

As described in the above, with providing the reflector 1519 to the solar cell, it is possible to return, to the photoelectric conversion member 1618D, light which passed through the photoelectric conversion member 1618D once. Thus, the light is directed to the photoelectric conversion member 1518D with improved irradiation efficiency to thereby improve power generation efficiency. The reflector 1519 may be in the form of a white plate reflecting and diffusing in various directions, or a mirror of regular reflection.

The communication device 12D is defined by the base plate 128D, the antenna 126 formed over the base plate 128D, and the communication circuit 127 (not shown) formed over the base plate 128D. The base plate 128D has its first surface (front surface) in its thickness direction defines a reflective surface configured to reflect visible light. The reflective surface can be formed by plating the front surface of the base plate 128D, for example. Besides, the antenna 126 is formed on the front surface of the base plate 128D to have a loop shape along an outer periphery of the base plate 128D. Therefore, a reflector function is located to a part (inside area and outside area of the antenna 126) other that a part on which the antenna 126 is formed. The communication device 12D is disposed in back of the photoelectric conversion member 1518D such that the front surface of the base plate 128D is faced to the photoelectric conversion member 1518D.

In the wireless identification card 10D of the present embodiment, the base plate 128D of the communication device 12D is used as the reflector 1519, and the solar cell 15D is defined by the base plate 128D and the photoelectric conversion member 1518D.

As described in the above, in the wireless identification card 10D of the present embodiment, the base plate 128D which is a structural part of the communication device 12D is used as the reflector 1519. In brief, the communication device 12D and the solar cell 15D share the base plate 128D. Therefore, it is possible to omit the reflector 1519, and to thin the laminate of the solar cell 15D and the communication device 12D.

FIG. 18B illustrates the wireless identification card 10E as a modification of the present embodiment. The wireless identification card 10E is different in the communication device 12E from the wireless identification card 10D. The communication device 12E is defined by the base plate 128, the antenna 126E formed over the base plate 126, and the communication circuit 127 (not shown) formed over the base plate 126.

The antenna 126E is formed on the first surface of the base plate 128 in its thickness direction to cover the approximately entire first surface. Further, the antenna 126E is configured to reflect visible light, and is formed by painting a surface of the antenna 126E white, by performing mirror finishing on the surface of the antenna 126E, and by plating the surface of the antenna 126E. That is, light reflectivity is given to the surface of the antenna 126E. The communication device 12E is placed over the rear surface of the photoelectric conversion member 1518D such that the front surface of the base plate 128 is faced to the photoelectric conversion member 1518D.

In the wireless identification card 10E shown in FIG. 18B, the antenna 126E is used as the reflector 1519, and the solar cell 16D is defined by the antenna 126E and the photoelectric conversion member 1518D.

As described in the above, the antenna 126E which is a structural member of the communication device 12E functions as the reflector 1519. That is, the communication device 12E and the solar cell 15D share the antenna 126E. Thus, it is possible to omit the reflector 1519, and to thin the laminate of the solar cell 15D and the communication device 12E.

Notably, the features of the wireless identification card 10D of the present embodiment can be applied to the wireless identification card 10B of the third embodiment and the wireless identification card 10C of the fourth embodiments. In this arrangement, it is possible to more thin the wireless identification cards 10B and 10C.

### Sixth Embodiment

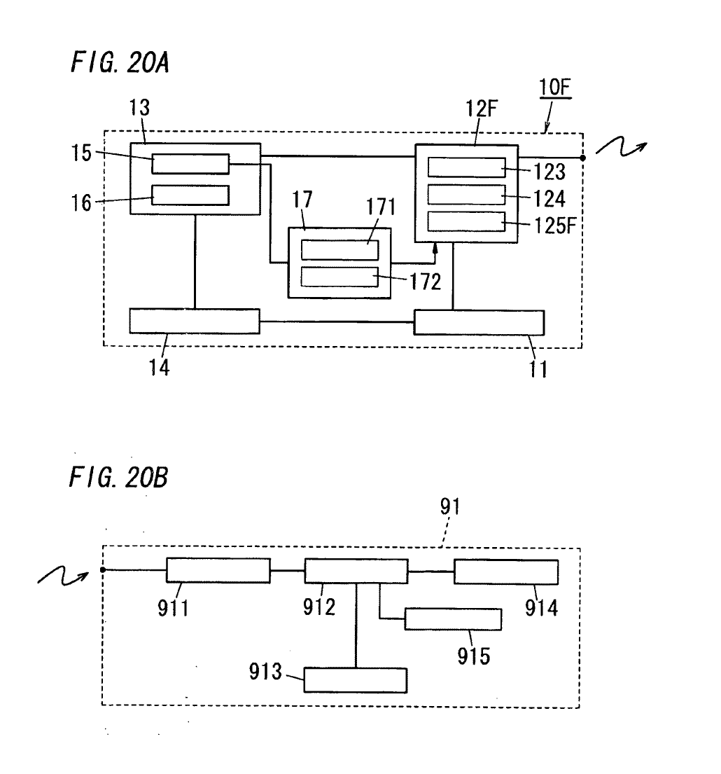

As shown in FIG. 20A, the wireless identification card 10F of the present embodiment is different from the wireless identification card 10 mainly in that the wireless identification card 10F is provided with the mode control device 17. The configurations common to the wireless identification card 10F of the present embodiment and the wireless identification card 10 of the first embodiments are designated by the same reference numerals, and no explanations thereof are deemed necessary.

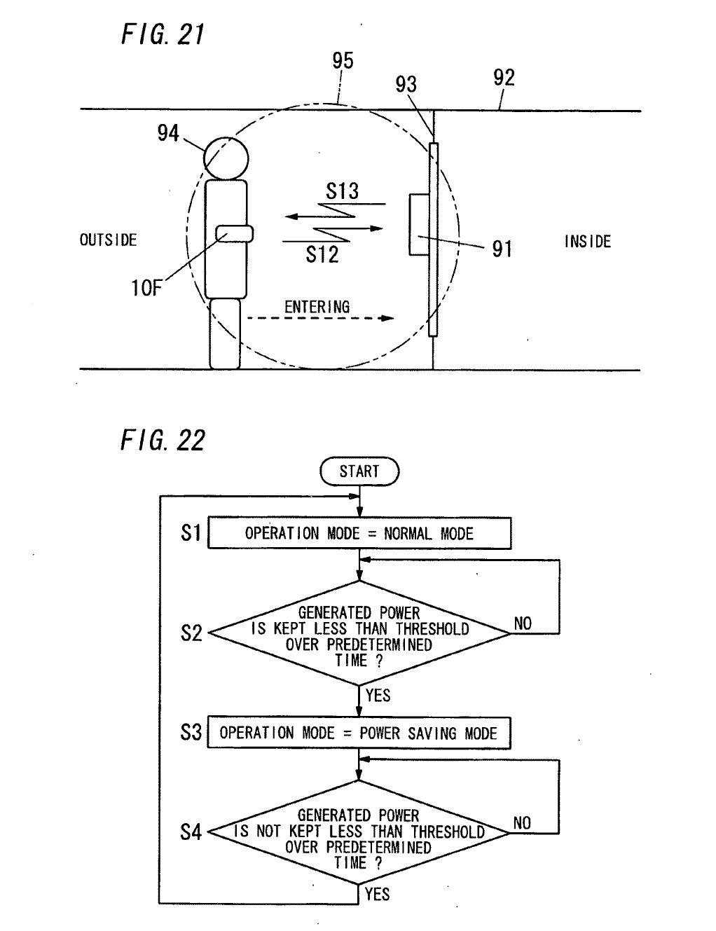

The wireless identification card 10F of the present embodiment constructs the entrance and exit management system in association with an authentication device (identification information reception device) 91 shown in FIG. 21 which is a reading device. The entrance and exit management system is used for managing an entrance of a room 92 being a target space, as shown in FIG. 21. The authentication device 91 is installed on a wall in a vicinity of an entrance and exit gate 93 of the room 92. The wireless identification card 10F is carried by a user 94. The wireless identification card 10F is configured to establish wireless communications with the authentication device 91.

The entrance and exit management system establishes the wireless communications between the wireless identification card 10F and the authentication 91 by electromagnetic wave as a medium, thereby performing authentication of the user 94 carrying the wireless identification card 10F. The entrance and exit management system determines, on the basis of result obtained by the authentication, whether or not the user is allowed to enter and exit to and from the room 92.

The wireless identification card 10F includes the identification information storage 11, the communication device 12F, the power supply device 13, the indication device 14, and the mode control device 17. The mode control device 17 is configured to select one from operation modes of the communication device 12F.

The communication device 12F includes the RF antenna 123, the RF communication circuit 124, and the communication control circuit 125F, for example. The communication control circuit 125F is configured to receive electrical power from the storage cell 16 of the power supply device 13, and is configured to transmit intermittently a wireless signal (i.e., an identification signal S12) including the identification information stored in the identification information storage 11. The electric power stored in the storage cell 16 is consumed each time the communication device 12F transmits the identification signal S12. Since the solar cell 15 receives sufficient light in normal use of the wireless identification card 10F, the solar cell 15 can generate electrical power (generated electric power) enough to supplement the electric power of the storage cell 16 consumed by transmission of the identification signal S12 by the communication device 12F. Thus, the storage cell 16 sees no substantial change in its remaining electrical power.

The authentication device 91 includes, as shown in FIG. 20B, a wireless communication device 911, an authentication processing device 912, a notification device 913, a lock control device 914, and a storage 915.

The wireless communication device 911 is configured to communicate with the communication device 12F of the wireless identification card 10F. The wireless communication device 911 receives the identification signal S12 transmitted from the wireless identification card 10F.

In a vicinity of the authentication device 91 (around the entrance and exit of the room 92) is formed an authentication area 95 defined as a range in which the wireless identification card 10F and the authentication device 91 can communicate with each other by use of electric wave. Therefore, when the user 94 who carries the wireless identification card 10F (namely, the wireless identification card 10F) exists within the authentication area 95, the authentication device 91 can receive the identification signal S12 (i.e., identification information) transmitted from the wireless identification card 10F.

The storage 915 is realized by a memory, for example, which is configured to store the identification information (valid identification information) corresponding to a user who is authorized to enter and exit to and from the room 92.

The authentication processing device 912 is configured to authenticate the identification information included in the identification signal S12 received by the wireless communication device 911. For example, the authentication processing device 912 is configured to check the identification information received by the wireless communication device 911 with the valid identification information stored in the storage 915 to perform authentication of the identification information. When the identification information received by the wireless communication device 911 is identical to the valid identification information, the authentication processing device 912 determines success of the authentication. In this situation, the authentication processing device 912 controls the wireless communication device 911 in a manner to transmit the acknowledge signal (ACK signal) S13 including the identification information authenticated successfully. In addition, in response to success of the authentication of the identification information, the authentication processing device 912 output an authentication success signal to the notification device 913 and the lock control device 914. In contrast, when the identification information received by the wireless communication device 911 is not identical to any valid identification information, the authentication processing device 912 determines failure of the authentication. In this situation, the authentication processing device 912 controls the wireless communication device 911 not to transmit the acknowledge signal S13, and outputs an authentication failure signal to the notification device 913 and the lock control device 914.

The notification device 913 is configured to issue, by use of sound and/or light, a result of the authentication of the identification information by the authentication processing device 912. The notification device 913 issues success of the authentication upon receiving the authentication success signal. The notification device 913 issues failure of the authentication and gives warning upon receiving the authentication failure signal.

The lock control device 914 is configured to control a lock device (not shown) installed in the entrance and exit door 93 of the room 92. Upon receiving the authentication success signal from the authentication processing device 912, the lock control device 914 controls the lock device of the door 93 to unlock the door 93. Upon receiving the authentication failure signal from the authentication processing device 912, the lock control device 914 controls the lock device of the door 93 to keep the door 93 locked.

Besides, a particular device connected to the authentication device 91 may have one or more parts of functions of the authentication device 91. For example, the said another device may have the authentication processing device 912. With this arrangement, said another device may check the identification information.

According to the aforementioned entrance and exit management system, the wireless identification card 10F communicates with the authentication 91 to transmit the identification information stored in the identification information device 11 to the authentication device 91. The authentication device 91 checks the identification information received from the wireless identification card 10F with a preliminarily registered data (valid identification information). Upon succeeding the authentication, the authentication device 91 unlocks the door 93. Upon failing the authentication, the authentication device 91 keeps the door 93 locked. According to the entrance and exit management system, it is possible to perform the entrance and exit management for the user 94, provided that the user carries the wireless identification card 10F.

The communication device 12F is configured to perform the operation mode selected from one of a normal mode and a power saving mode. The normal mode and the power saving mode have different frequencies of transmission of the identification information. In the normal mode, the communication control circuit 125F transmits the identification signal S12 at a predetermined first period (e.g., 1 second). While, in the power saving mode, the communication control circuit 125F transmits the identification signal S12 at a predetermined second period (e.g., 10 second) longer than the first period. As described in the above, the communication device 12F operates in one of the operation modes having the different frequencies of transmission of the identification information. The frequency of transmitting the identification information is defined as the number of times per a predetermined time for the transmission of the identification information. The power saving mode may be smaller in the number of times per a predetermined time for the transmission of the identification information than the normal mode. For example, with regard to the power saving mode, the number of transmission of the identification information may be zero (namely, transmission of the identification signal S12 is terminated).

The communication device 12F consumes electric power each time the communication device 12F transmits the identification information. Accordingly, consumed power per a predetermined time increases with an increase of frequency of transmission of the identification information. Thus, the power saving mode is smaller in power consumption (consumed power per a predetermined time) than the normal mode.

The mode control device 17 is configured to switch the operation mode of the communication device 12F between the normal mode and the power saving mode.

The mode control device 17 includes a measurement device 171 configured to measure generated electrical power of the solar cell 15. Further, the mode control device 17 includes a switching device 172 configured to determine surrounding luminance of the wireless identification card 10F on the basis of the measurement result of the measurement device 171, and switch the operation mode of the communication device 12F corresponding to the measured surrounding luminance. As shown in FIG. 22, the mode control device 17 selects the normal mode as the operation mode of the communication device 12F in an initial state (S1).

The switching device 172 switches the operation mode of the communication device 12F from the normal mode to the power saving mode, upon judging, on the basis of a first criterion, that the surrounding luminance does not exceed a predetermined value while the communication device 12F operates in the normal mode.

In more detail, the switching device 172 compares a predetermined first threshold with the generated electric power of the solar cell 15 obtained from the measurement device 171. When the generated electric power does not exceed the first threshold, the switching device 172 activates a timer (not shown). While the generated electric power is less than the first threshold, the switching device 172 keeps the timer operating. When the timer finishes counting a first predetermined time, the switching device 172 judges that the surrounding luminance of the wireless identification card 10F is less than the predetermined value. In brief, the first criterion is defined as to whether or not the generated electric power of the solar cell 15 is kept less than the first threshold over a predetermined time. Besides, when the generated electric power is not less than the first threshold after the timer is activated, the switching device 172 resets the timer. As described in the above, when the generated electric power of the solar cell 15 is kept less than the first threshold over the predetermined time while the communication device 12F is in the normal mode (S2: Yes), the mode control device 17 determines that the surrounding luminance is less than the predetermined value, and switches the operation mode of the communication device 12F to the power saving mode (S3).

Accordingly, when the generated electric power of the solar cell 15 becomes less than the first threshold only temporarily, the operation mode of the communication device 12F is not switched to the power saving mode. When the generated electric power is kept less than the first threshold over the predetermined time, the operation mode of the communication device 12F is switched to the power saving mode. Therefore, in a situation where the user 94 uses the wireless identification card 10F in the entrance and exit management system, even if the generated electric power of the solar cell 15 becomes temporarily less than the first threshold due to an instant decrease in intensity of light coming into the solar cell 15 interfered by shadow of a hand of the user 94, for example, the operation mode of the communication device 12F is not switched to the power saving mode.

The switching device 172 switches the operation mode of the communication device 12F from the power saving mode to the normal mode, upon judging, on the basis of a second criterion, that the surrounding luminance exceeds the predetermined value while the communication device 12F operates in the power saving mode.

In more detail, while the communication device 12F operates in the power saving mode, the switching device 172 compares the predetermined first threshold with the generated electric power of the solar cell 15 obtained from the measurement device 171. When the generated electric power is not less than the first threshold, the switching device 172 activates the timer (not shown). While the generated electric power is not less than the first threshold, the switching device 172 keeps the timer operating. When the timer finishes counting a second predetermined time, the switching device 172 judges that the surrounding luminance of the wireless identification card 10F exceeds the predetermined value. In brief, the second criterion is defined as to whether or not the generated electric power of the solar cell 15 is kept exceeding the first threshold over a predetermined time. Besides, when the generated electric power is less than the first threshold after the timer is activated, the switching device 172 resets the timer. As described in the above, when the generated electric power of the solar cell 15 is kept exceeding the first threshold over the predetermined time while the communication device 12F is in the power saving mode (S4: Yes), the mode control device 17 determines that the surrounding luminance exceeds the predetermined value, and switches the operation mode of the communication device 12F to the normal mode (S1).

Each criterion includes two parameters, that is, the first threshold and time (time in which the generated electric power kept less than the first threshold, or time in which the generated electric power kept not less than the first threshold). The first predetermined time of the first criterion is greater than the second predetermined time of the second criterion.

In more detail, the switching device 172 judges that the surrounding luminance goes below the predetermined value when the generated electrical power is kept less than the first threshold over 1 minute. The first threshold is defined as a value corresponding to the generated electric power which the solar cell 15 generates under the surrounding luminance of 10 lx. Therefore, when the surrounding luminance of the wireless identification card 10F is kept less than 10 lx over 1 minute, the operation mode of the communication device 12F is switched to the power saving mode. The switching device 172 judges that the surrounding luminance exceeds the predetermined value when the generated electrical power is kept not less than the first threshold over 2 seconds. Therefore, when the surrounding luminance of the wireless identification card 10F is kept not less than 10 lx over 2 seconds, the operation mode of the communication device 12F is switched to the normal mode.

Thus, in the present embodiment, the first criterion is set to be lower than the second criterion for switching the operation mode. Therefore, the operation mode is more likely to be switched while the communication device 12F is in the power saving mode than in the normal mode. Thus, it is enabled to avoid inconvenient situation of keeping the wireless identification card 10F in the power saving mode in a condition where the communication device 12F is not switched from the power saving mode to the normal mode during the use of the wireless identification card 10F by the user.

Besides, the first predetermined time and the second predetermined time are not limited to the aforementioned instances. For example, the first predetermined time may be 10 minutes. Further, the first criterion and the second criterion may have the different first threshold.

The measurement device 171 of the mode control device 17 monitors a voltage, a current, and/or an electrical power output from the solar cell 15 to measure the generated electrical power of the solar cell 15. For example, the measurement device 171 measures the voltage, the current, and/or the electrical power under a condition where an arbitrary load is connected to the solar cell 15. Alternatively, the measurement device 171 measures the voltage of the solar cell 15 in an open state, or the current of the solar cell 15 in a short circuit state.

The aforementioned entrance and exit management system includes the authentication device 91 and the wireless identification card 10F. The authentication device 91 is placed around the entrance of the target region such as the room 92. The wireless identification card 10F is defined as an identification device configured to communicate with the authentication 91 and destined to be carried by the user 94. In this entrance and exit management system, when the identification information is transmitted from the wireless identification card 10F to the authentication device 91, the authentication device 91 performs authentication of the identification information, and determines, on the basis of a result of the authentication, whether the user 94 is authenticated to enter and exit to and from the target region.

The wireless identification card 10F includes the identification information storage 11, the communication device 12F, the power supply device 13, and the mode control device 17. The identification information storage 11 is configured to store the identification information. The communication device 12F is configured to establish the wireless communications with the authentication device 91 to transmit the identification information to the authentication device 91. The power supply device 13 includes the solar cell 15 and the storage cell 16 and is configured to supply electric power to the communication device 12F. The solar cell 15 is configured to generate an electric power in response to reception of light. The storage cell 16 is configured to store the electric power generated by the solar cell 15. The communication device 12F is configured to operate in the two operation modes, one being the normal mode, and the other being the power saving mode. In the normal mode, the communication device 12F transmits the identification information to the authentication device 91 at a predetermined period. The power saving mode is lower, in a frequency at which the communication device 12F transmits the identification information to the authentication device 91, than the normal mode. The mode control device 17 is configured to perform measurement of the generated electric power of the solar cell 15, and switch the operation mode of the communication device 12F in conformity with the surrounding luminance which is determined on the basis of a result of the measurement. Especially, upon judging, on the basis of the predetermined criterion, that the surrounding luminance is less than the predetermined value, the mode control device 17 switches the operation mode of the communication device 12F to the power saving mode.

According to the wireless identification card 10F of the present embodiment, when the surrounding luminance of the wireless identification card 10F is less than the predetermined value, the operation mode of the communication device 12F is switched to the power saving mode. The power saving mode is lower in a transmission frequency of the identification information lower than the power saving mode. Consumed power at the communication device 12F in the power saving mode is lower than that in the normal mode. When the wireless identification card 10F is stored in a dark room (e.g., a drawer, a bag, a pocket of clothes, a locker, and a closet) in which the solar cell 15 fails to receive sufficient light while the user 94 does not use the wireless identification card 10F, it is possible to suppress a decrease in remaining power of the storage cell 16. Thus, in contrast to a situation where the communication device 12F always operates in the normal mode, it is possible to suppress a decrease in remaining power of the storage cell 16. Therefore, it is possible to prevent occurrence of an undesired situation where the communication between the wireless identification card 10F and the authentication device 91 fails to be established due to a shortage of remaining power of the storage cell 16. Thus, the entrance and exit management system can be free from failure and operate normally (the user 94 is allowed to enter and leave a room).

For example, provided that the authentication device 91 is installed in user's office, the user 94 does not use the wireless identification card 10F on one's way home, and the wireless identification card 10F need not transmit the identification information. Therefore, provided that the user 94 leaves the user's office, power consumed when the communication device 12F transmits the identification information is wasteful. According to the wireless identification card 10F of the present embodiment, by decreasing the transmission frequency of the identification information while the wireless identification card 10F is not used, an increase in wasteful power consumption is suppressed as possible. Thus, it is possible to suppress a decrease in the remaining power of the storage cell 16 (it is possible to suppress an increase in power consumption).

In addition, in the wireless identification card 10F, when the surrounding luminance of the wireless identification card 10F exceeds the predetermined value, the operation mode of the communication card 10F is switched to the normal mode from the power saving mode. Consequently, when the user 94 uses the wireless identification card 10F, the transmission frequency of the identification information is increased, and therefore a waiting time for transmission of the identification information is shortened.

As described in the above, according to the wireless identification card 10F, the communication device 12F operates in the power saving mode while the wireless identification card 10F is not used (while the wireless identification card 10F need not communicate with the authentication device 91). Thus, in contrast to a situation where the communication device 12F operates in the normal mode, it is possible to reduce consumption of power stored in the storage cell 16. The communication device 12F operates in the normal mode while the wireless identification card 10F is used (while the wireless identification card 10F need communicate with the authentication device 91). Thus, in contrast to a situation where the communication device 12F operates in the power saving mode, it is possible to decrease a waiting time starting when the user 94 comes close to the authentication device 91 and ending when the door 93 is unlocked. Therefore, it is possible to improve usability of the entrance and exit management system.

The power generated by the solar cell 15 relates to intensity of light coming into the solar cell 15, that is, the surrounding luminance of the wireless identification card 10F. Therefore, the mode control device 17 judges the surrounding luminance of the wireless identification card 10F on the basis of the result of the measurement of the power generated by the solar cell 15. In brief, the solar cell 15 is used as a luminance sensor (a sensor configured to measure luminance). Therefore, since an additional luminance sensor is unnecessary, it is possible to suppress an increase in the number of parts assembling the wireless identification card 10F.

Alternatively, the mode control device 17 may be configured to compare a predetermined threshold with an amount of generated power of the solar cell 15 (i.e., accumulated power generated by the solar cell 5 for a predetermined time). Further, the mode control device 17 may be configured to, when the amount of generated power of the solar cell 15 becomes less than the predetermined threshold, judge that the first criterion is fulfilled and that the surrounding luminance become less than the predetermined value. Alternatively, the mode control device 17 may be configured to, when the amount of generated power of the solar cell 15 exceeds the predetermined threshold, judge that the second criterion is fulfilled and that the surrounding luminance exceeds the predetermined value. With this arrangement, the surrounding luminance is judged to be less than the predetermined value unless the amount of generated power of the solar cell 15 exceeds the predetermined threshold. Thus, for example, even when the user 94 puts the wireless identification card 10F in one's pocket and the generated power of the solar cell 15 increases momentarily due to momentary irradiation of intensive light to the solar cell 15 in the pocket, the communication device 12F is kept operating in the power saving mode. Besides, when the amount of generated power becomes not less than predetermined threshold, the communication device 12F is switched to the normal mode.

Alternatively, the switching device 172 of the mode control device 17 may be configured to judge that the surrounding luminance goes below the prescribed value, when the generated power of the solar cell 15 becomes less than a first threshold and also when a variation per a predetermined time of the generated power becomes less than a second threshold (when the generated power does not change beyond a second threshold for a predetermined time). In addition, the switching device 171 may be configured to judge that the surrounding luminance exceeds the predetermined value, when the generated power of the solar cell 15 becomes not less than the first threshold and also when the variation per a predetermined time of the generated power becomes not less than the second threshold (when the generated power is changed beyond the second threshold within the predetermined time).

With the arrangement, the first threshold is corresponding to the generated power of the solar cell 15 obtained when the surrounding luminance of the wireless identification card 10F is 10 lx. The second threshold is corresponding to the generated power of the solar cell 15 obtained when the surrounding luminance of the wireless identification card 10F is 200 lx. When the surrounding luminance of the wireless identification card 10F is less than 10 lx and when the surrounding luminance does not changes beyond 200 lx within 1 minute, the operation mode of the communication device 12F is switched to the power saving mode. In contrast, when the surrounding luminance of the wireless identification card 10F is not less than 10 lx and when the surrounding luminance changes beyond 200 lx within 2 seconds, the operation mode of the communication device 12F is switched to the normal mode.

With this arrangement, when the wireless identification card 10F is placed in a dark room, the operation mode of the communication device 12F is switched to the power saving mode. After the wireless identification card 10F is taken out from the dark room, the operation mode of the communication device 12F is switched to the normal mode in response to a change in the surrounding luminance of the wireless identification card 10F. When a change in the generated power is not less than the second threshold, the mode control device 17 does not wait a predetermined time (e.g., 2 seconds) but switches the operation mode to the normal mode. When the user 94 takes out the wireless identification card 10F from a pocket of user's clothes for example, the operation mode of the communication device 12F is immediately switched from the power saving mode to the normal mode. Therefore, it is possible to prevent the wireless identification card 10F from being kept in the power saving mode even when the user uses the wireless identification card 10F.

The authentication device 91 may be configured to open and close an automatic-door, or an automatic ticket gate, for example. Moreover, the wireless identification card 10F and the authentication device 91 may be configured to establish communications (wireless communications) with each other by means of electromagnetic induction.

1. A wireless identification card comprising:
an identification information storage configured to store identification information;
a transmitter configured to transmit a wireless signal including the identification information stored in said identification information storage; and
a solar cell configured to supply electrical power to said transmitter,
wherein said solar cell includes a sensitizing material having sensitization action, an electron transport member, and a hole transport member.

2. The wireless identification card as set forth in claim 1, wherein
said wireless identification card comprises:
an indication unit shaped into a plate shape and configured to indicate predetermined visual information; and
a main body shaped into a card shape and configured to hold said identification information storage and said transmitter,
said sensitizing material being a dye which generates an electron and a hole in response to reception of light,
said solar cell being shaped into a plate shape, and further including a working electrode, and an opposite electrode, said electron transport member being made of a semiconductor layer and configured to support said sensitizing material, said working electrode being formed over a first surface of said electron transport member in its thickness direction and configured to receive an electron from said sensitizing material, said opposite electrode being formed over a second surface of said electron transport member in its thickness direction, said hole transport member being defined as an electrolyte layer interposed between said electron transport member and said opposite electrode and configured to receive a hole from said sensitizing material, and
one of said solar cell and said indication unit being configured to have translucency, and disposed over a front surface of said main body such that the other of said solar cell and said indication unit is interposed between said one of the solar cell and the indication unit and said main body.

3. The wireless identification card as set forth in claim 2, wherein
said indication unit is configured to have translucency, and is disposed over said front surface of said main body such that said solar cell is interposed between said indication unit and said main body,
said wireless identification card including a diffusion transmission member interposed between said indication unit and said solar cell, and
said diffusion transmission member being configured to, upon receiving light, diffuse the light used for visual indication by said indication unit, and transmit the light used for electrical generation of said solar cell.

4. The wireless identification card as set forth in claim 2, wherein
said solar cell has translucency for visible light, and is disposed over said main body such that said indication unit is interposed between said solar cell and said main body.

5. The wireless identification card as set forth in claim 4, wherein
said indication unit has translucency, and
said wireless identification card including a background plate which is disposed over a rear surface of said indication unit and is configured to improve visibility of visual indication by said indication unit.

6. The wireless identification card as set forth in claim 4, wherein
said indication unit has translucency, and
said wireless identification card including a reflective plate which is disposed over a rear surface of said indication unit and is configured to reflect the light which passes through said indication unit.

7. The wireless identification card as set forth in claim 2, wherein
said wireless identification card further comprises:
a receiver is configured to receive a wireless signal including indication information which defines visual indication indicated by said indication unit; and
an indication information storage configured to store the indication information received by said receiver,
said indication unit being configured to make visual indication corresponding to the indication information stored in said indication information storage, and
said solar cell being configured to energize said receiver and said indication unit.

8. The wireless identification card as set forth in claim 7, wherein
said wireless identification card further comprises an updating device configured to update contents of the indication information stored in said indication information storage to contents of the indication information received by said receiver.

9. The wireless identification card as set forth in claim 2, wherein
said indication unit is disposed over said front surface of said may body such that said solar cell is interposed between said indication unit and said main body,
said solar cell being defined by common base plate, and a photoelectric conversion member formed over said common base plate, said photo electric conversion member including said working electrode, said semiconductor layer, said electrolyte layer, and said opposed electrode, and
said transmitter being defined by said common base plate, an antenna formed over said common base plate, and a communication circuit formed over said common base plate and configured to transmit a wireless signal by use of said antenna.

10. The wireless identification card as set forth in claim 9, wherein
said photoelectric conversion member, said antenna, and said communication circuit are formed over a surface of said common base plate in its thickness direction.

11. The wireless identification card as set forth in claim 9, wherein
said photoelectric conversion member is formed over a first surface of said common base plate in its thickness direction,
said antenna and said communication circuit being formed over a second surface of said common base plate in its thickness direction.

12. The wireless identification card as set forth in claim 9, wherein
said wireless identification card further includes a storage cell configured to store electrical power generated by said solar cell,
said storage cell being defined by said common base plate and a storage cell member formed over said common base plate.

13. The wireless identification card as set forth in claim 2, wherein
said indication unit is disposed over said front surface of said may body such that said solar cell is interposed between said indication unit and said main body,
said solar cell being defined by a photoelectric conversion member and a reflector, said photoelectric conversion member being defined by said working electrode, said semiconductor layer, said electrolyte layer, and said opposed electrode, and said reflector being configured to reflect light which passes through said photoelectric conversion member,
said transmitter being defined by a base plate, an antenna formed over said base plate, and a communication circuit formed over said base plate and configured to transmit a wireless signal by use of said antenna, and
said reflector being said base plate or said antenna.

14. The wireless identification card as set forth in claim 2, wherein
said wireless identification card further includes a storage cell configured to store electrical power generated by said solar cell,
said indication unit being disposed over a front surface of said solar cell,
said solar cell being defined by a common base plate and a photoelectric conversion unit formed over said common base plate and including said working electrode, said semiconductor layer, said electrolyte layer, and said opposed electrode, and
said storage cell being defined by said common base plate and a storage cell member formed over said common base plate.
